(19) United States
(12) Patent Application Publication
(10) Pub. No.: US 2015/0350469 A1
(43) Pub. Date: Dec. 3, 2015

(54) INFORMATION PROCESSING APPARATUS, AND METHOD OF CONTROLLING INFORMATION PROCESSING APPARATUS

(71) Applicant: CANON KABUSHIKI KAISHA, Tokyo (JP)

(72) Inventor: Yoshiji Kanamoto, Abiko-shi (JP)

(21) Appl. No.: 14/721,638

(22) Filed: May 26, 2015

(30) Foreign Application Priority Data
Jun. 2, 2014 (JP) 2014-114373

(51) Int. Cl. H04N 1/00; B65H 43/00; B65H 37/04

(52) U.S. Cl. CPC H04N 1/00466; B65H 37/04; B65H 43/00; H04N 1/00639; H04N 1/00663

(57) ABSTRACT

A setting for sheet processing including a selection of binding processing is received, and when the setting for the sheet processing is received, an attribute of a sheet for which binding can be performed without using a staple from out of a plurality of attributes of sheets is displayed identifiably.

### BACKGROUND OF THE INVENTION

1. Field of the Invention

The present invention relates to a technique of print setting.

2. Description of the Related Art

The print on demand market which uses digital printers in place of offset printing devices which have been widely used in conventional commercial printing is expanding. Also, without being limited to production use digital printers for the previously described commercial printing, even for multi-function peripherals that are installed in office environments, various types of functions have been incorporated from digital printers which have a main objective of production use. As a result, there are environments in which multi-function peripherals that include various general-purpose functions and are provided for usage with multiple objectives. A representative example of the previously mentioned various functions is various types of a finishing function.

Punching processing for opening a hole in media that configures an output material, binding processing which physically binds a bundle of media by staples, or the like (also called binding processing) and various folding processing and the like are widely adopted on multi-function peripherals as a finishing functions. Also, as a special form of binding processing, a multi-function peripheral can use processing for saddle stitching when creating a saddle binding result of for gluing in case binding as kinds of finishing function. Additionally, in a wide sense, trimming processing which trims edge portions i.e. edges and a top and bottom of a saddle binding result (as previously mentioned) or a case binding result, and sorting processing which performs shift discharging when stacking sheets, are classified as kinds of finishing processing. A configuration is taken in which a finishing apparatus which realizes these various finishing functions is mountable on a multi-function peripheral, and user needs and use cases are flexibly supported.

The finishing functions described above are shown as examples that can generally be applied in multi-function peripherals, and actually, multi-function peripherals in recent years are configured such that various finishing functions and apparatuses other than those described above are use able in combination with the multi-function peripheral.

In recent years, in addition to the previously described finishing apparatuses, binding processing that is known as stapleless binding is also useable. Stapleless binding is one kind of the previously described bindings. In other words, it is a kind of function for bundling media to configure an output material of multiple sheets. In the staple binding which corresponds to a conventional binding processing, multiple sheets of media are bundled by a staple which is made out of metal being caused to penetrate a sheet, and also folding edge portions of the staple such that the staple is in a flattened form. In contrast to this, stapleless binding has a characteristic in that a metal or corresponding binding component which is used in staple binding is not used. In other words, a binding arrangement for stapleless binding is as shown.

For stapleless binding, a strong pressure is applied towards media which configures a bundle by a component having an unevenness referred to as a tooth. Stapleless binding is a method in which by this pressure, a binding force is achieved by causing the state the media, or more generally the state of the fibers of the media between mediums that are contacting each other to change and to stick together.

In stapleless binding, as the name of the function indicates, it is possible to generate a bundle without using staples. For this reason, stapleless binding is different from staple binding which conventionally common, and there exist several advantages in the point that a metal component is not required.

First is the point that, since staples are not used, it is possible to discard, as is, output material that has become unnecessary by using a shredder or the like. In the case of a resulting document of staple binding, since there is the possibility that the metal parts (the staples) may damage the cutting unit of the shredder, generally processing is performed on the shredder once the staples are removed. At that time, it is necessary to take the step of removing the staples and the step of discarding the metal when the staples are removed.

Additionally, in recent years, there also exists an important factor in a change in awareness with respect to the environment of the user of a multi-function peripheral. There are also exist situations wherein the resource conservation characteristic of the stapleless binding of not using consumables, in contrast to conventional staple binding, is treated as having a direct value for customers and users who have high environmental consciousness.

Arrangement and convenience of stapleless binding, which multi-function peripherals having come to be equipped with in recent years, is as described in this description of the related art. However, while there are the previously described advantages to the stapleless binding function mainly in contrast to staple binding, there also exist several problems from the perspective of convenience.

First is the point that, since stapleless binding is a method for causing mediums to adhere to each other by applying pressure to a media bundle as previously explained, the adhesive force is weak compared to the staple binding approach in which media is bundled by causing staples to penetrate the bundle. In other words, the force required to detach or disconnect media from the bundle is small when the force is applied in a direction in which the media of the sheet bundle, in the form in which the media are adhered to each other, is opened.

Second is the point that for the stapleless binding, what kind of media is used has a large effect on the arrangement for configuring the bundle. Here, the type of media indicates, a type of paper which is identified by a combination of several physical characteristics by which for example, paper properties such as grammage, surface characteristics, or the like, are identified. In other words, there exists media that is suitable for stapleless binding and media which is not suitable for stapleless binding. While even in the case of staple binding there exist a type of media such as thick paper through which staples cannot be caused to penetrate, based on the difference in the arrangements for achieving the binding force, there are overwhelmingly more media types to which staple binding can be applied when compared to stapleless binding.

Third is the point that, even in the case where the media is suitable for stapleless binding, the maximum number of sheets for which binding is possible is smaller compared to staple binding. When stapleless binding processing is applied in a case where the number of sheets to which it can be applied is exceeded, media which configures the resulting document is easily separated, and it is difficult to obtain an effect that is expected by a user.

Fourth, for stapleless binding, even in a case where media is of the same type, and each of the mediums is suitable for stapleless binding, there is a possibility that the binding force will be influenced by elements of the media storage environment such as humidity and the like.

Fifth is the point that, as described above, a user stapleless binding is not something that a user can recognize easily, even though there exist various restriction items.

As described above, with the stapleless binding function, despite its convenience, in order to enjoy its merits, i.e. in order for a user to obtain a valid resulting document, various items must be considered. In a case when a user permits the use of stapleless binding in a state in which a condition for the media to be suitable for stapleless binding is not met, even when an inappropriate resulting document is obtained, the user will find it difficult to know the reason as to why the resulting document is inappropriate. Also, because it is difficult to know the reason as to why the resulting document is inappropriate, it is also difficult to know how to avoid this, and it is difficult to know what operation should be performed to obtain an appropriate result.

### SUMMARY OF THE INVENTION

The present invention was conceived of in view of the problems surrounding stapleless binding processing as described above. In other words, the present invention provides a technique for providing information necessary for an appropriate resulting document so that a user can effectively use a function of an apparatus for performing stapleless binding, thereby enabling the user to obtain a desired resulting document avoiding the various above described problems that are specific to stapleless binding.

According to the first aspect of the present invention, there is provided an information processing apparatus, comprising: a reception unit configured to receive a setting for sheet processing including a selection of binding processing; and a display unit configured to, when the reception unit receives the setting for the sheet processing, display identifiably an attribute of a sheet for which binding can be performed without using a staple from out of a plurality of attributes of sheets.

According to the second aspect of the present invention, there is provided a method of controlling an information processing apparatus, comprising: a reception step of receiving a setting for sheet processing including a selection of binding processing; and a display step of, when the setting for the sheet processing is received in the reception step, displaying identifiably an attribute of a sheet for which binding can be performed without using a staple from out of a plurality of attributes of sheets.

Further features of the present invention will become apparent from the following description of exemplary embodiments (with reference to the attached drawings).

### BRIEF DESCRIPTION OF THE DRAWINGS

FIG. 1 is a view for illustrating an example configuration of a system.

FIG. 2 is a block diagram for showing an example of a hardware configuration of a multi-function peripheral 200.

FIG. 3 is a cross-sectional view of inside of a sheet processing apparatus 250.

FIG. 4 is a view for illustrating a vicinity of a tooth.

FIG. 5 is a view for illustrating an embodiment of a resulting document where a stapleless binding is applied.

FIG. 6 is a view for illustrating an example of computer programs stored in a ROM 207.

FIG. 7 is a view for illustrating a GUI display example.

FIG. 8 is a view for illustrating a GUI display example.

FIG. 9 is a view for illustrating a GUI display example.

FIG. 10 is a view for illustrating a GUI display example.

FIG. 11 is a flowchart of processing performed by a controller unit 205.

FIG. 12 is a flowchart of processing performed by the controller unit 205.

FIG. 13 is a view for illustrating a GUI display example.

FIG. 14 is a view for illustrating a GUI display example.

FIG. 15 is a flowchart of processing performed by the controller unit 205.

FIG. 16 is a view for illustrating a GUI display example.

FIG. 17 is a flowchart of processing performed by the controller unit 205.

FIG. 18 is a view for illustrating a GUI display example.

FIG. 19 is a view for illustrating a GUI display example.

FIG. 20 is a view for illustrating a GUI display example.

FIG. 21 is a flowchart of processing performed by the controller unit 205.

FIG. 22 is a block diagram for showing an example of a hardware configuration of a computer 101.

FIG. 23 is a view for illustrating an example of computer programs saved in an HDD 2211.

FIG. 24 is a view for illustrating a GUI display example.

FIG. 25 is a view for illustrating a GUI display example.

### DESCRIPTION OF THE EMBODIMENTS

Below, explanation will be given for embodiments of present invention with reference to the accompanying drawing. Note that embodiments described below merely illustrate examples of specifically implementing the present invention, and are only specific embodiments of a configuration defined in the scope of the claims.

### First Embodiment

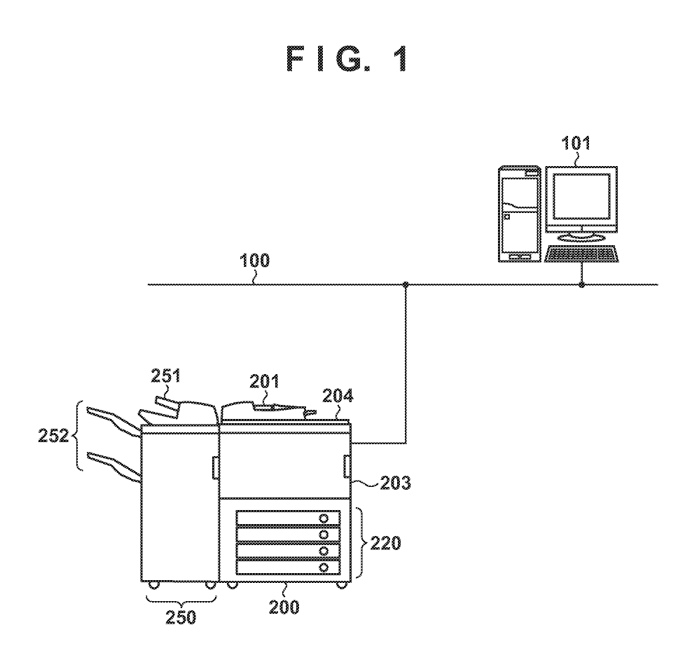

Firstly, explanation is given for an example configuration of a system which can execute image printing (image printing and text printing are referred to collectively as image printing) and post-processing according to the present embodiment using FIG. 1. As shown in FIG. 1, the system according to the present embodiment comprises a computer 101 and a multi-function peripheral 200, and they are connected through a network 100 such as a LAN or the Internet.

Note that below explanation is given with an example of the configuration shown in FIG. 1, but the configuration of a system capable of executing processing as explained below is not limited to the configuration shown in FIG. 1. For example, the numbers of instances of the computer 101 or the multi-function peripheral 200 are not limited to one, and the configuration of the multi-function peripheral 200 is also not limited to the configuration shown in FIG. 1.

Firstly, explanation will be given for the computer 101. The computer 101 is a device such as a PC (personal computer) or a portable terminal device, and an apparatus capable of generating and transmitting a job (a job for causing a printing of an image or text on a sheet, or a job for causing an execution of post-processing in addition to the printing to the sheet). Of course, the computer 101 may generate and transmit any job if the job is for causing the multi-function peripheral 200 print or execute post-processing to the printed sheet. The job transmitted from the computer 101 is transmitted to the multi-function peripheral 200 through the network 100. Note that there is a case where the job includes various setting data for the job.

Next, explanation will be given for the multi-function peripheral 200. The multi-function peripheral 200 is an apparatus capable of executing image printing on a sheet or post-processing on a sheet to which an image is printed. In the present embodiment, it is assumed that the multi-function peripheral 200 is at least able to execute binding processing using staples and binding processing without using staples as post-processing.

Various types (sizes, materials, or the like) of sheets can be contained in a sheet feeding unit 220, the sheets contained in the sheet feeding unit 220 are conveyed to a printer unit 203, and an image or text is printed by the printer unit 203.

The printer unit 203 is for printing an image or text on a sheet according to a job generated inside the multi-function peripheral 200 or a job received from the computer 101, and for example the following configuration can be applied to the printer unit 203.

A light beam for example a laser beam which is modulated in response to the job (image data) supplied to the printer unit 203 is caused to be irradiated by a rotational polygonal mirror (such as a polygon mirror), and is irradiated onto a photosensitive drum via a reflection mirror as reflected scanning light. A latent image formed on the photosensitive drum by the laser beam is developed by a toner, and a toner image is transferred onto a sheet pressed to a transfer drum. By successively executing the sequence of image forming processes for each of yellow (Y), magenta (M), cyan (C), and black (K) toners, a full color image is formed. Also, configuration may be taken in which a toner referred to as a special color, a transparent toner, or the like, in addition to the four colors can be transferred. The sheet on a transfer drum on which the full color image is formed is conveyed to a fixing unit. The fixing unit is configured by a combination of a roller and a belt, a heat source such as a halogen heater is built-in, and the toner on the sheet material to which the toner image is transferred is melted and fixed by heating and pressure.

A scanner unit 201 is for reading as an image information such as an image or text recorded on the set sheet, and sending the read image data to the printer unit 203.

An operation unit 204 comprises a touch panel screen and hard keys, can provide various information to an operator through the touch panel screen, and can receive an input of various information from the operator through the touch panel screen or the hard keys.

A post-processing apparatus capable of executing post-processing can connected to the printer unit 203, and a sheet processing apparatus 250 is connected as the post-processing apparatus in the present embodiment. The sheet processing apparatus 250 is an apparatus for applying various processing to a sheet where an image or text is printed and for obtaining a resulting document in the printer unit 203. “Processing” mentioned here includes staple binding processing where an edge portion of a bundle of sheets conveyed from the printer unit 203 is closed by staples, and bookbinding processing where a central portion of a bundle of sheets conveyed from the printer unit 203 is bound by staples and folded along the staples. Also, stapleless binding processing where an edge portion of a bundle of sheets, which are conveyed from the printer unit 203, is closed by pressure being applied to the edge portion by teeth, and punching processing which performs a punch pressing process on edges of the sheets conveyed from the printer unit 203 are included in “processing”.

An inserter 251 is arranged on the sheet processing apparatus 250. The inserter 251 inserts a sheet set on the inserter 251 at an appropriate timing based on settings for sheets conveyed from the printer unit 203. By the inserter 251, a sheet not required to be printed can be inserted between the sheets already printed.

An output tray 252 is arranged on the sheet processing apparatus 250. The output tray 252 forms a tray unit for discharging and stacking a sheet (output material) processed by the sheet processing apparatus 250.

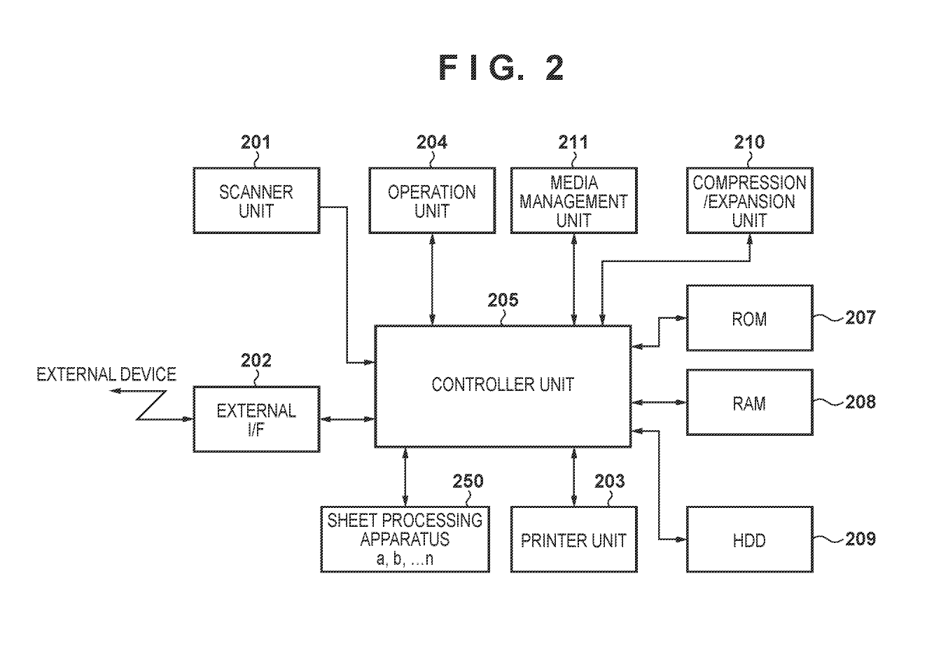

Next, explanation is given for a hardware configuration example of the multi-function peripheral 200 using a block diagram in FIG. 2. Note that FIG. 2 shows a main configuration appearing in an explanation of operations of the multi-function peripheral 200, but does not show the configuration of all of the multi-function peripheral 200. Also, the configuration in FIG. 2 is only one example, and the configuration of the multi-function peripheral 200 is not limited to the configuration in FIG. 2.

The scanner unit 201 reads information recorded on a set sheet as an image, and sends the read image to an HDD (hard disk drive) 209 after appropriate image processing is applied to the read image. The image to which the image processing is applied may be saved in the HDD 209 after being compressed by a compression/expansion unit 210.

As described above, the operation unit 204 comprises the touch panel screen or the hard keys, and comprises a display function for displaying various information and an information input function for enabling an operator to input various information.

A media management unit 211 manages types (a sheet size, a grammage, a material, or the like) of sheets which can be processed by the multi-function peripheral 200, and at least in the present embodiment, manages information relating to a sheet suitable for stapleless binding processing. Of course, configuration may also be taken such that, for each type of post-processing, information relating to sheets suitable for the type of post-processing is managed. Anyway, the form of the management of the information relating to the sheets in the media management unit 211 is not limited to a particular form of management if the information relating to the sheets suitable for the post-processing of the designated type can be obtained in a case where the type of the post-processing is designated. Also, the management of the sheet types by the media management unit 211 is performed in the HDD 209.

The compression/expansion unit 210 is for performing compression or expansion of data i.e. expanding compressed image in a job transmitted from the computer 101 or compressing an image read by the scanner unit 201.

An external I/F (interface) 202 is for functioning as an interface for the multi-function peripheral 200 to connect to the above described network 100, and the multi-function peripheral 200 performs transmission/reception of data with the computer 101 through the external I/F 202.

As described above, the sheet processing apparatus 250 is for executing the post-processing on sheets to which images or text is printed in the printer unit 203, and as described above, and at least the binding processing using staples and the binding processing that does not use staples are included in the post-processing in the present embodiment.

As described above, the printer unit 203 is for printing an image or text on a sheet in accordance with a job generated inside of the multi-function peripheral 200 or a job received from the computer 101, and the already printed sheet is conveyed to the sheet processing apparatus 250 of a subsequent stage.

Job data received from the computer 101 through the external I/F 202 can be saved, and the image (which is appropriately compressed by the compression/expansion unit 210) that the scanner unit 201 reads can be saved in the HDD 209. Also, information relating to the sheets which the media management unit 211 manages is saved in the HDD 209. Another storage apparatus may be used in place of or in addition to the HDD 209 if the same objective can be achieved.

A controller unit 205 performs an operation control of the multi-function peripheral 200 on the whole and executes or controls each process explained later as something that the multi-function peripheral 200 performs by executing the processing using a computer program or data stored in a ROM 207 or a RAM 208.

Setting data that is not changed in the multi-function peripheral 200, a boot program of the multi-function peripheral 200, computer programs for causing the controller unit 205 to execute or to control each process explained later as something that the multi-function peripheral 200 performs, data, or the like, are stored in the ROM 207. The computer programs or the data stored in the ROM 207 are appropriately loaded into the RAM 208 according to the control of the controller unit 205 and become a processing target of the controller unit 205.

The RAM 208 comprises an area for storing the computer programs or the data loaded from the HDD 209, or job data received from the computer 101 through the external I/F 202. Furthermore, the RAM 208 comprises a work area used in a case where the controller unit 205 executes various the processing. In this way, the RAM 208 can provide various areas as appropriate.

In this kind of configuration, the multi-function peripheral 200 can realize a so-called copy function, for example, where after an image read by the scanner unit 201 is read from the HDD 209 and is expanded by the compression/expansion unit 210, the image is caused to be printed on a sheet by the printer unit 203. Also, the multi-function peripheral 200 can realize a function where an image in a job received from the computer 101 through the external I/F 202 is printed on a sheet by the printer unit 203. In this way, the multi-function peripheral 200 is an MFP type printing apparatus (also referred to as an image forming apparatus). Note that the multi-function peripheral 200 may be a printing apparatus capable of color printing, a printing apparatus capable of monochrome printing, or may be an apparatus capable of switching between these.

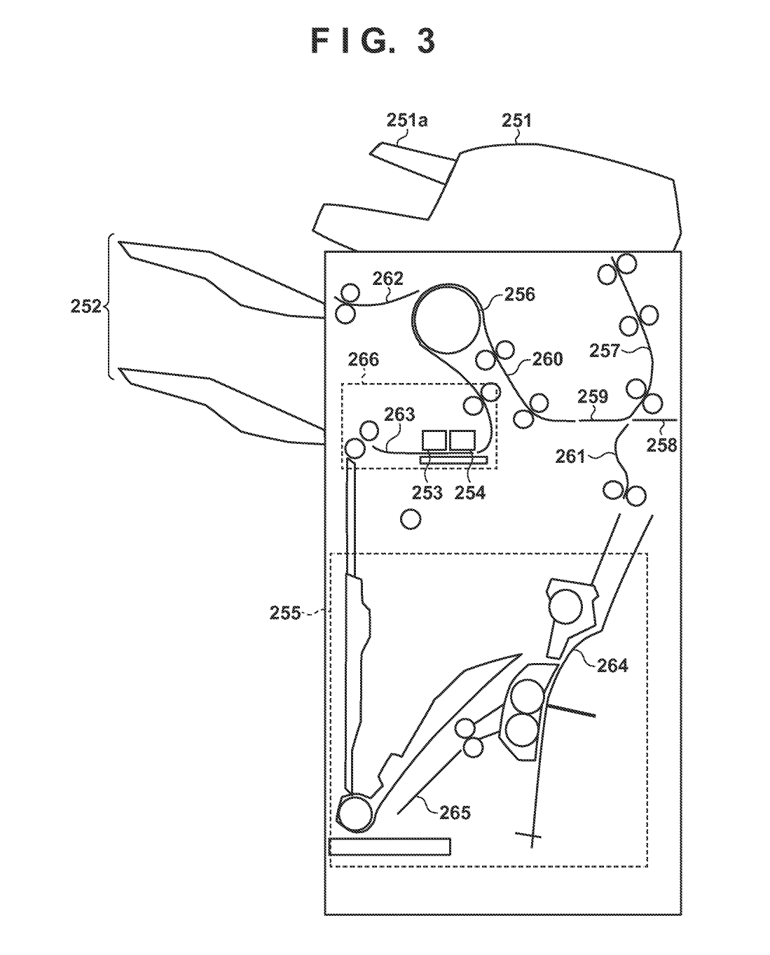

Next, explanation is given for an example configuration of the inside of the sheet processing apparatus 250 using FIG. 3 which indicates a cross-sectional view of the inside of the sheet processing apparatus 250. A circular shaped component described in the cross-sectional view of the sheet processing apparatus 250 indicated in FIG. 3 is a roller used upon conveyance of a sheet. Also, paths represented in a linear form and arranged between rollers indicate conveying paths (257, 258, 259, 260, 261, 262, 263, 264, 265) where sheets conveyed by the roller pass through. Control is performed so that sheets pass through these rollers and along these conveying paths, and processing of the sheets is performed by various sheet processing arranged on the conveying path at that time.

The inserter 251 is a unit for supplying a sheet installed in an insert tray 251a to the sheet processing apparatus 250. A punch unit 256 is an apparatus for performing a punch pressing process on edges of the sheets conveyed to the sheet processing apparatus 250. A bookbinding unit 255 is a unit for performing bookbinding processing where a sheet conveyed to the sheet processing apparatus 250 is bundled, a staple binding process is applied at a central portion, and in addition the bundle is folded at the central portion along the staples.

A staple binding apparatus 254 and a stapleless binding apparatus 253 are arranged on a trailing edge on a conveying path 263, and a buffer path unit 266 including the conveying path 263, the staple binding apparatus 254, and the stapleless binding apparatus 253 is configured. The buffer path unit 266 is a unit responsible for a role of accumulating a required number of processing target sheets in order to apply the staple binding processing and the stapleless binding processing to multiple sheet bundles.

As described above, the staple binding apparatus 254 and the stapleless binding apparatus 253 that configure the buffer path unit 266 are arranged on the trailing edge in relation to a sheet conveyance direction. In FIG. 3, the staple binding apparatus 254 and the stapleless binding apparatus 253 are arranged in a direction parallel to the conveyance direction, but actually, configuration may be taken such that the staple binding apparatus 254 and the stapleless binding apparatus 253 are arranged at close and far sides with respect to the conveyance direction in FIG. 3. The arrangement in FIG. 3 of the unit handling the binding processing merely shows an example.

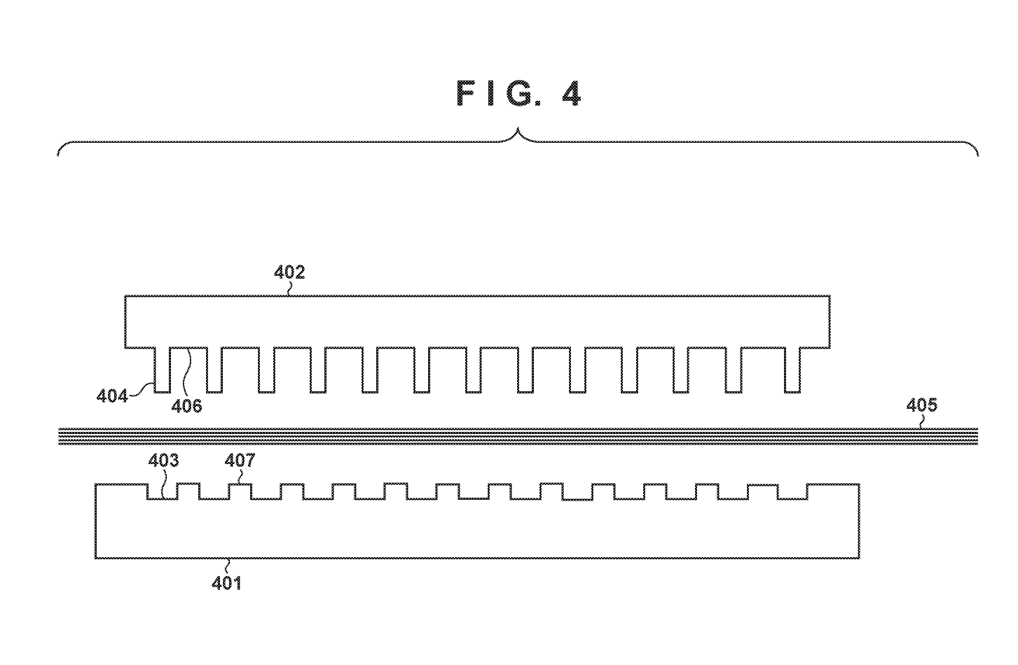

A vicinity of teeth for the application of the stapleless binding processing by the stapleless binding apparatus 253 shown in FIG. 3 to a sheet bundle is shown in FIG. 4. The teeth are comprised of units 401 and 402 as shown in FIG. 4, both of the units 401 and 402 comprise concave portions 403 and 406 and convex portions 404 and 407, and these are respectively arranged to engage with each other. A binding force can be caused to occur at between each of the pinched sheets by applying strong pressure on a region where the concave/convex portions engage in a state in which a sheet bundle 405 which is the target of the application of the teeth binding is pinched vertically by the units 401 and 402.

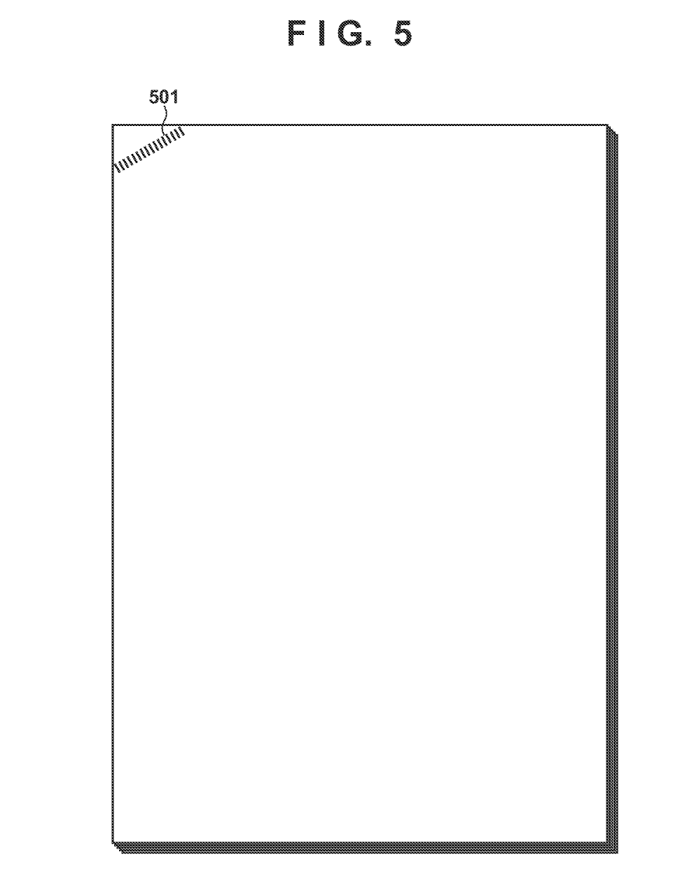

FIG. 5 is a view for illustrating an embodiment of a resulting document where a stapleless binding is applied. The stapleless binding processing is applied as is shown by an edge portion (a portion corresponding to the top-left area of the bundle in FIG. 5) 501 of a sheet bundle. The linear forms shown in the figure are locations of stapleless binding application which configures the result where pressure was applied vertically by the concave/convex portions of the teeth in FIG. 4 to the sheet bundle.

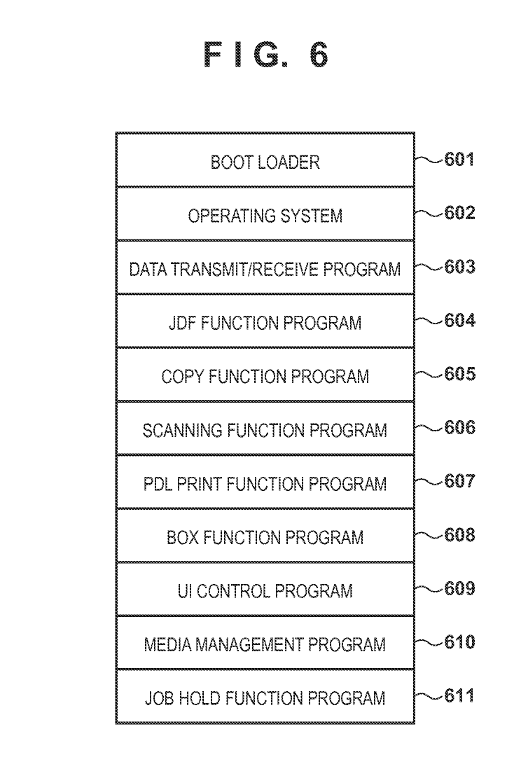

Next, explanation is given for one example of computer programs stored in the ROM 207 using FIG. 6. The computer programs shown in FIG. 6 are merely one example, and cases where more computer programs are stored in the ROM 207 can be considered. Of course, configuration may be taken such that the computer programs indicated in FIG. 6 are comprised in a plurality of computer programs, and conversely configuration may be taken such that a plurality of computer programs are comprised in one computer program.

A boot loader 601 is a computer program executed immediately after a power supply activation of the multi-function peripheral 200. The boot loader 601 includes a computer program for executing various activation sequences required upon an activation of the multi-function peripheral 200.

An operating system 602 is a computer program intended to provide an execution environment for various computer programs to realize the functions of the multi-function peripheral 200. It mainly provides functions, such as basic input/output control of a memory (resource management of the ROM 207, the RAM 208, the HDD 209, or the like, in the case of FIG. 2) of the multi-function peripheral 200, various apparatuses shown in FIG. 2, or the like.

A data transmit/receive program 603 is a control program executed in order to perform a data communication with the computer 101 through the external I/F 202. More specifically, it contains a protocol stack such as that of TCP/IP, and is a control program for performing communication of various data communicated between the computer 101 via the network 100. The communication processing performed here is processing specialized to data packet transmission/reception or HTTP server communication processing, and is not included in analysis processing relating to content of received data described later. Analysis processing of data is performed by an execution of another computer program explained later.

A JDF function program 604 is a computer program executed, based on the job, in a case where JDF job data (print job data) is received from the computer 101 through the external I/F 202, in order to realize a JDF print function.

In the JDF print function performed by the controller unit 205 executing the JDF function program 604, operation of each device is instructed successively in the appropriate order by the controller unit 205 based on a processing order and processing conditions described in this program. As a result, the JDF print processing function ends up being realized. For example, a JDF print processing function is realized by making successive instructions for operation of the sheet processing apparatus 250, the printer unit 203, the HDD 209, the compression/expansion unit 210, the RAM 208, or the like. Also, a computer program performing analysis processing on the JDF job data received from the computer 101 through the external I/F 202, classification process determining whether or not an incorrect setting is included in the JDF job data by analysis processing, setting change processing for cancelling the incorrect setting, or the like, is included.

A copy function program 605 is a computer program executed in order to perform display control of a screen displayed on the operation unit 204 in order to realize a copy function, various instructions corresponding to the copy function which are input by an operator operating the operation unit 204, and information management.

In the copy function performed by the controller unit 205 executing the copy function program 605, operation of each device is successively instructed in an appropriate order by the controller unit 205 based on a processing order and processing conditions described in this program. With this, the copy function ends up being realized. For example, the copy function is realized by successively instructing operation of the scanner unit 201, the printer unit 203, the sheet processing apparatus 250, the HDD 209, the compression/expansion unit 210, the RAM 208, or the like.

A scanning function program 606 is a computer program executed in a case where the operator operates the operation unit 204 and inputs a scan instruction, and is the scanning function program 606 realizes a scanning function which is executed by the controller unit 205 according to the instruction.

The scanning function, which is performed by the controller unit 205 executing the scanning function program 606, is executed as follows. Namely, for each device such as the scanner unit 201, the HDD 209, the compression/expansion unit 210 and the RAM 208, the resources of the multi-function peripheral 200 are controlled by the controller unit 205 based on a processing order and processing conditions described in this program. At that time, the scanning function ends up being realized by successively instructing operation of devices in an appropriate order.

A PDL print function program 607 is a computer program executed in order to realize the PDL print function based on the PDL job data (print job data) transmitted from the computer 101.

In the PDL print function performed by the controller unit 205 executing the PDL print function program 607, operation of devices is successively instructed in an appropriate order by the controller unit 205 based on a processing order and processing conditions described in this program. As a result, the PDL print function ends up being realized. For example, the PDL print function is realized by making successive instructions for operation of the sheet processing apparatus 250, the printer unit 203, the HDD 209, the compression/expansion unit 210, the RAM 208, or the like.

A box function program 608 is a computer program executed in a case where an operator instructs execution of the box function by operating the operation unit 204, and the box function program 608 realizes the box function which is executed by the controller unit 205 upon the instruction.

The box function is realized by successively instructing operation of devices in an appropriate order by the controller unit 205 based on a processing order and processing conditions described in this program. For example, the box function is realized by successively instructing operation of the scanner unit 201, the printer unit 203, the sheet processing apparatus 250, the HDD 209, the compression/expansion unit 210, the RAM 208, or the like. Also, with this program, for stored job data, execution can be performed changing settings upon storing.

A UI control program 609 is a program for controlling the operation unit 204. The UI control program 609 is a computer program that is executed, in a case where an operator operates the operation unit 204, in order to perform inter-program communication with a computer program corresponding to the operation to activate the computer program corresponding to the operation.

A media management program 610 is a computer program executed by the controller unit 205 in order to control the media management unit 211. In other words, it is a computer program executed in order to manage information (sheet sizes, grammage, material, or the like) relating to sheet which the multi-function peripheral 200 can process, and as described above, it manages information relating to sheets suitable for stapleless binding processing, for example. The information relating to sheets managed by the execution of this program is saved and managed in the HDD 209, for example.

A job hold function program 611 is a computer program which is executed in a case when an operator operates the operation unit 204 and instructs the execution of the job hold function, and the job hold function is realized when the controller unit 205 executes this program.

In the job hold function, print processing due to a job hold is controlled so as to be executed by the controller unit 205 instructing sequentially operation of devices in an appropriate order based on a processing order and processing conditions described in this program. For example, by sequentially instructing operation of the printer unit 203, the sheet processing apparatus 250, the HDD 209, the compression/expansion unit 210, the RAM 208 and the like, the job hold function is realized. Also, with this program, for stored job data, execution can be performed changing settings upon storing.

When storing print job data for a job hold function of the multi-function peripheral 200 from the computer 101, the PDL print function program 607, the JDF function program 604, or the like, instructs storage corresponding to the job hold function in place of processing for printing the job data.

Whether to perform a print instruction by the PDL print function program 607 or the JDF function program 604, and whether to perform storage processing in the job hold function is designated on the side of a printing application which operates on the computer 101 which is the origin of the input of the job. This designation is reflected in a setting attribute for job data which is the target of processing by the PDL print function program 607 or the JDF function program 604, and the PDL print function program 607 or the JDF function program 604 performs switching of processing based on the setting attribute.

Hereinafter, in a case when explaining operation of the controller unit 205, there are cases in which it is not touched upon which of the above described computer programs the controller unit 205 executes for that operation. However, based on the explanation of the above described functions of the computer program, it would be clear if one is skilled in the art which of the above described computer programs performs the operation which will be explained as being executed by the controller unit 205 below.

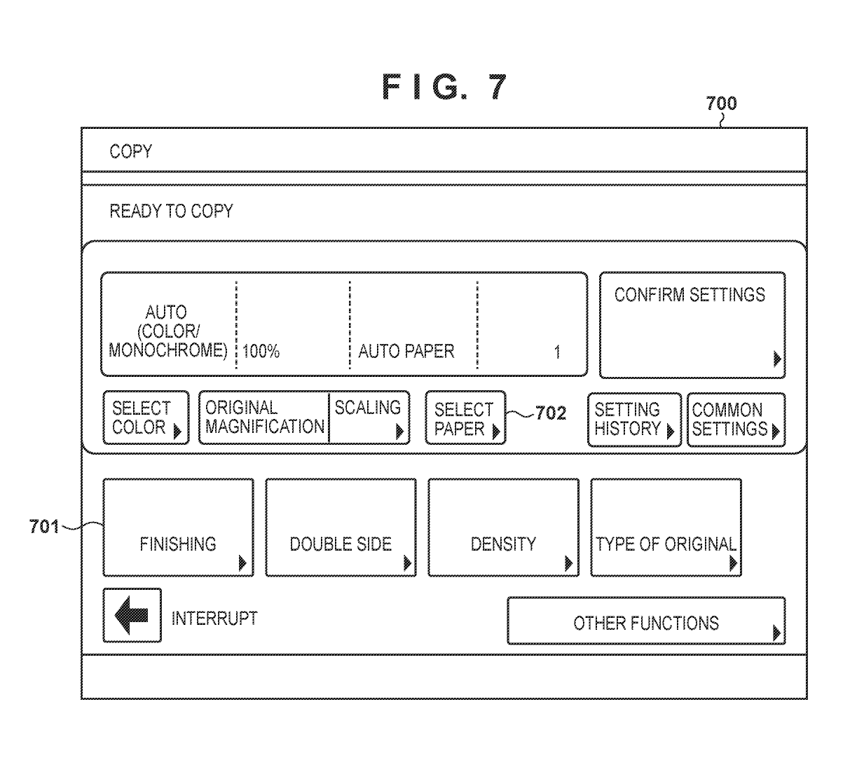

Next, an explanation is given using FIGS. 7-10 of a screen group which is displayed on a display screen of the operation unit 204 as a result of the controller unit 205 executing the copy function program 605 described above. Additionally, display control of the screens which are shown in FIGS. 7-10, and recording/management of various instructions and information which is input through this screen is all performed by the controller unit 205 executing the copy function program 605.

Firstly, an explanation will be given using FIG. 7 of a main copy screen. The main copy screen shown in FIG. 7 is a GUI (Graphical User Interface) 700 for performing various settings corresponding to copying. When a user operates hard keys or touches a location corresponding to the GUI 700 which is displayed on a display screen comprised in the operation unit 204, various settings corresponding to copying can be performed.

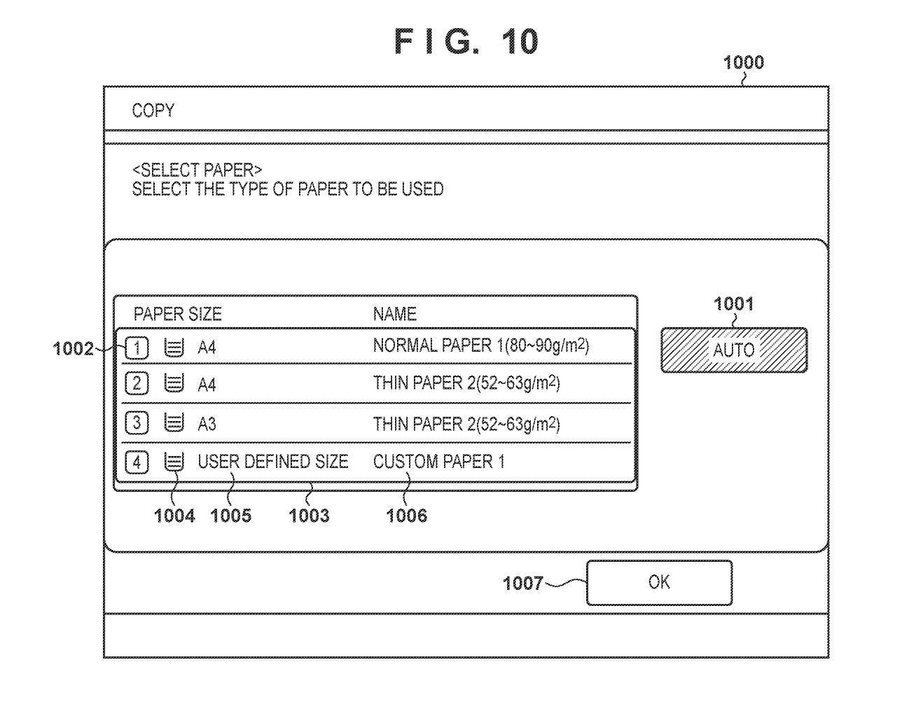

A button 702 is a button for instructing selection of a sheet (a piece of paper) which is used for copying, and when an operator touches the button 702, the display screen of the operation unit 204 switches from the GUI 700 to a GUI 1000 of FIG. 10. The GUI 1000 of FIG. 10 will be explained later.

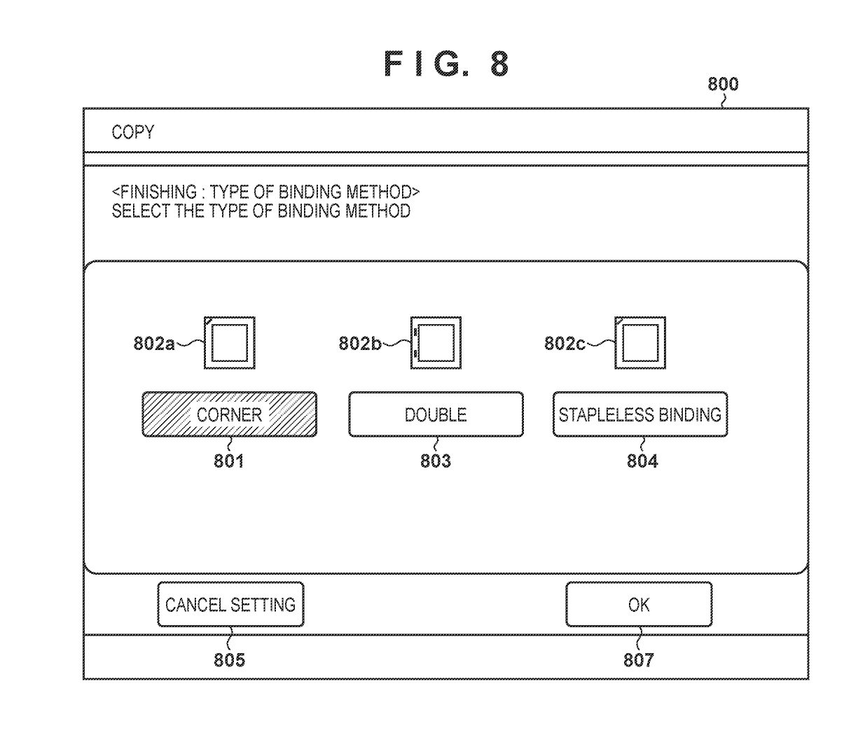

A finishing button 701 is a button for instructing selection of post-processing (finishing processing) which is performed on sheets on which text or an image is printed by the copy function. Finishing processing indicates all processing of a resulting document such as the above described staple binding, stapleless binding, bookbinding processing process, punching processing and the like. Hereinafter, an explanation will be given for a case when either staple binding or stapleless binding is selected as finishing processing. If an operator touches the finishing button 701, a display screen of the operation unit 204 switches from the GUI 700 to a GUI 800 of FIG. 8.

A button 801 in the GUI 800 of FIG. 8 is a button for selecting staple binding as finishing processing and designating a corner of a sheet as a position of staple binding. An icon 802a shows a state in which staple binding is performed on a corner of a sheet.

A button 803 is a button for selecting staple binding as finishing processing and designating 2 locations (double) on a left side of a sheet as the positions of the staple binding. An icon 802b shows a state in which staple binding is performed at two locations on a left side of a sheet.

A button 804 is a button which designates stapleless binding as the finishing processing. An icon 802c shows a state in which stapleless binding is performed on a sheet.

In FIG. 8, the button 801 is displayed so as to be darker compared to the other buttons 803 and 804, and this represents that the button 801 is designated.

When a user touches a button 807 on the GUI 800, the controller unit 205 stores, in the HDD 209, setting content in accordance with the button designated by the GUI 800. For example, in the case that the button 807 is designated after the button 801, or the button 803 is designated, a setting for the staple binding apparatus 254 is stored to the HDD 209. On the other hand, in the case when the button 804 is designated after the button 807 is designated, a setting for the stapleless binding apparatus 253 is stored to the HDD 209.

Meanwhile, when an operator touches a button 805, the controller unit 205 discards the content set using the GUI 800, and switches the display screen of the operation unit 204 from the GUI 800 to the GUI 700.

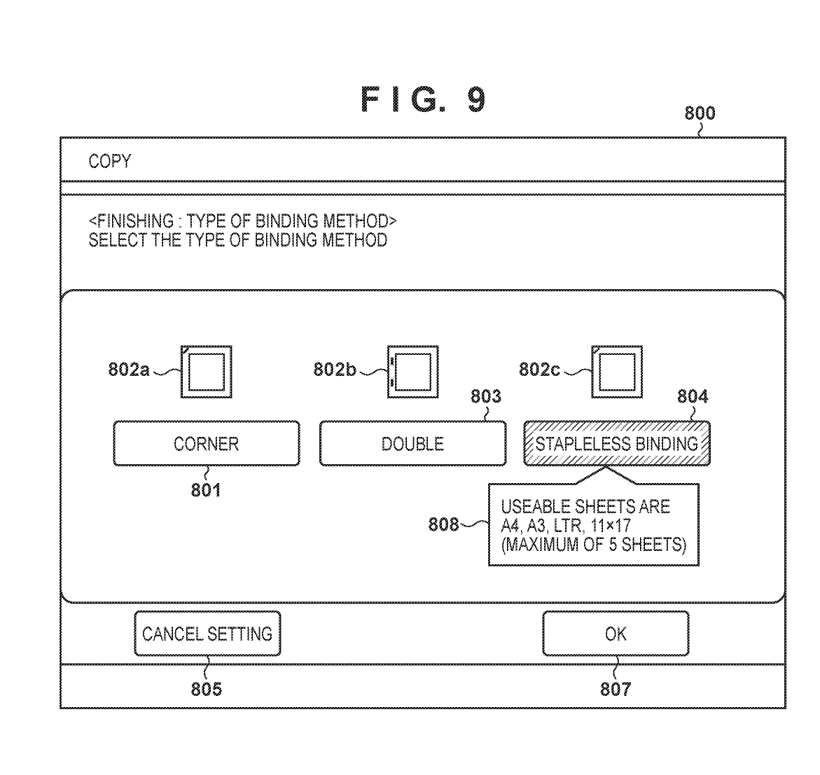

Here, when an operator touches the button 804, i.e. when stapleless binding is selected, the controller unit 205 obtains “information concerning sheets suitable for stapleless binding processing” which the media management unit 211 manages within the HDD 209. This information relates to information about conditions and settings which are suitable when executing stapleless binding processing. The controller unit 205, as shown in FIG. 9, displays a message 808 based on this obtained information.

In FIG. 9, information concerning a size of a sheet suitable for stapleless binding, and information concerning an upper limit on the number of sheets that is suitable for stapleless binding is displayed as the message 808. Of course information concerning sheets suitable for stapleless binding processing is not limited to the information indicated in FIG. 9, and various information can be considered. For example, types of sheet and grammages are given. Also, complicated conditions and information of the previously described combinations and the like can be information which is presented.

When, in the state shown in FIG. 9, i.e. a state in which the button 804 is in a selected state and the message 808 is being displayed, the button 801 or the button 803 is designated, the selected state of the button 804 is cancelled, and the message 808 is deleted (not displayed). Then the designated button enters a selected state.

In this way, an environment which improves efficiency of usage can be provided to an operator without adversely affecting the convenience of the stapleless binding function when an operator selects stapleless binding as the post-processing, since information concerning sheets which are suitable for stapleless binding is displayed on the display screen of the operation unit 204.

As described above, when an operator touches the button 702, a display screen of the operation unit 204 switches from the GUI 700 to the GUI of FIG. 10. In the GUI 1000 of FIG. 10, a button 1001 is a button for automatic selection; the button 1001 is for designating a paper selection mode which automatically determines a corresponding sheet size for use during output based on a size of a sheet which is processed for a copy job. In FIG. 10, the button 1001 is in a selected state.

Inside of an area 1002, information concerning sheets which are set for the sheet feeding unit 220 is listed, and in FIG. 10, a number 1003, a remaining amount of sheets 1004, a sheet size 1005, and a sheet name 1006 of each of the sheet feeding units comprised by the sheet feeding unit 220 is listed. For the area 1002, when the operator touches a corresponding tray column, sheets of the corresponding tray column are selected as the sheets which are used for printing. In such a case the selected state of the button 1001 is cancelled. Additionally, information displayed within the area 1002 is information which the media management unit 211 manages within the HDD 209. The media management unit 211 obtains this information from the HDD 209, and by passing it to the controller unit 205, the controller unit 205 is able to display a list of this information within the area 1002.

Then when the operator touches a button 1007, the content (the selected sheet) set for the GUI 1000 is registered to the HDD 209. This setting is used when determining sheets which are used during actual printing.

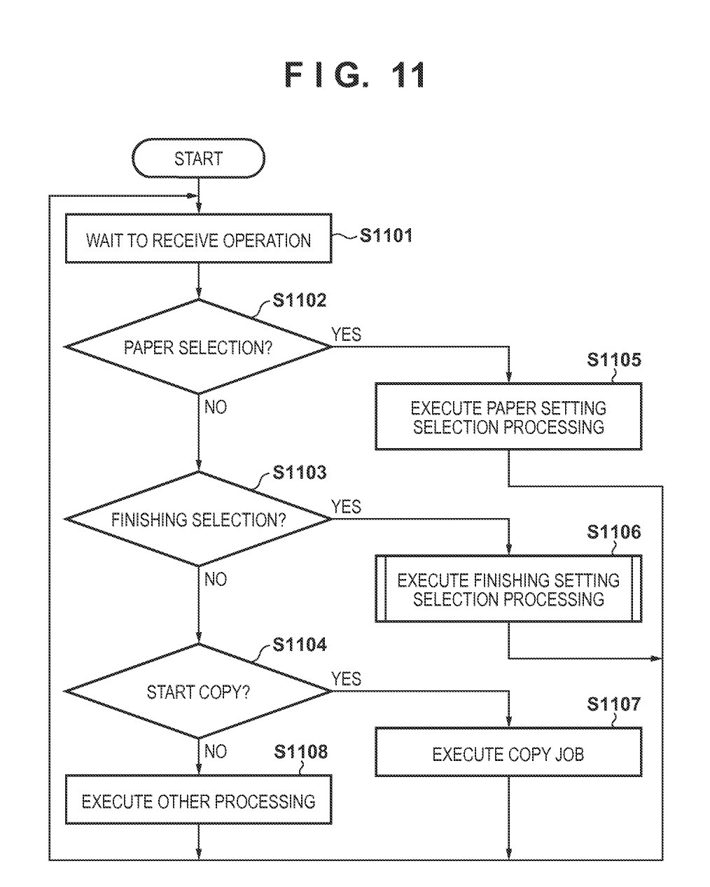

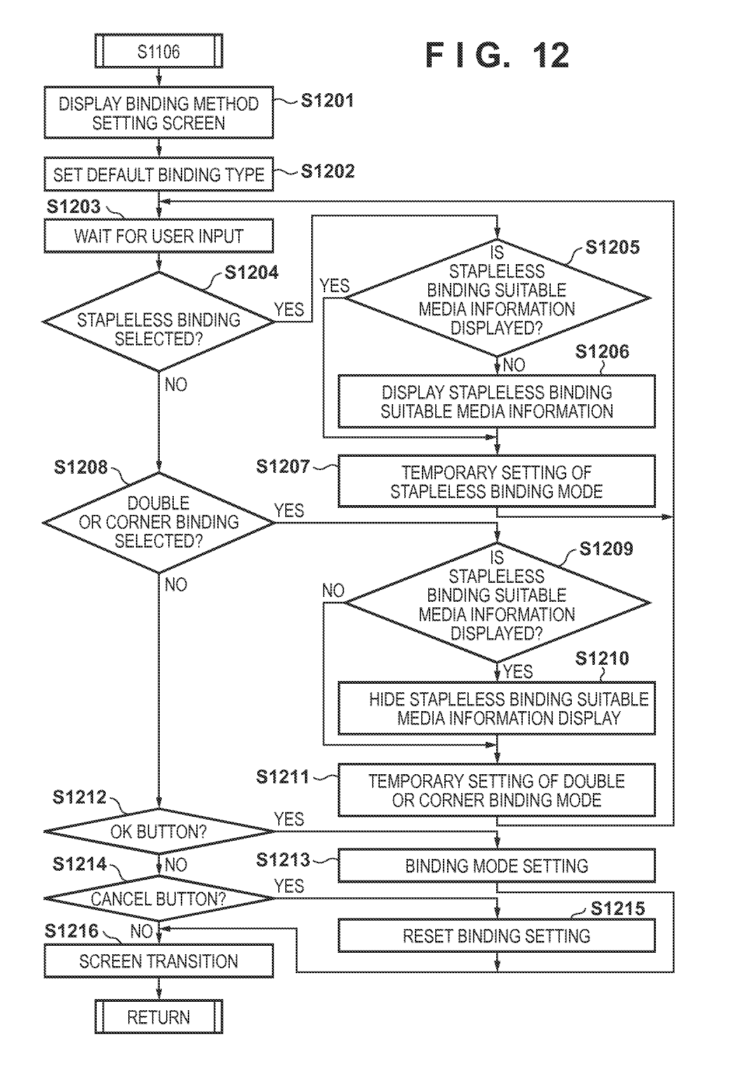

Next, an explanation will be given for processing which is performed by the controller unit 205 executing the copy function program 605 described above using flowcharts for the same processing shown in FIG. 11 and FIG. 12. Additionally, at the point in time when processing is started according to the flowchart in FIG. 11, it is assumed that the GUI 700 of FIG. 7 is displayed in the display screen of the operation unit 204.

In step S1101, the controller unit 205 waits for an input of an instruction from an operator through the operation unit 204. Then, in a case when an input of an instruction through the operation unit 204 is detected, the processing proceeds to step S1102.

In step S1102, the controller unit 205 determines whether or not the button 702 is designated, in other words, it determines whether or not an input of an instruction for performing paper selection is detected. In the case that the result of this determination is that the button 702 is designated, the processing proceeds to step S1105, and in the case that the button 702 is not designated, the processing proceeds to step S1103.

In step S1105, the controller unit 205 displays the GUI 1000 in FIG. 10 in place of the GUI 700 to the display screen of the operation unit 204, and receives operations corresponding to the area 1002 and the buttons 1001 and 1007. Then when the controller unit 205 detects that the button 1007 has been touched, in addition to registering the content that has been set using the GUI 1000 to the HDD 209, it displays the GUI 700 in place of the GUI 1000 to the display screen of the operation unit 204. Then the processing returns to step S1101.

On the other hand, in step S1103, the controller unit 205 determines whether or not the button 701 is designated on the GUI 700. In the case that the result of this determination is that the button 701 is designated, the processing proceeds to step S1106, and in the case that the button 701 is not designated, the processing proceeds to step S1104.

In step S1106 the controller unit 205 displays the GUI 800 in FIG. 8 in place of the GUI 700 to the display screen of the operation unit 204, receives an operation in relation to the GUI 800 from an operator, and executes processing based on these operations. Details on the processing in step S1106 will be explained later using FIG. 12.

On the other hand, in step S1104 the controller unit 205 determines whether or not a copy start button (not shown), which is comprised in the operation unit 204, is instructed. In the case that the result of this determination is that the copy start button is instructed, the processing proceeds to step S1107, and in the case that the copy start button is not instructed, the processing proceeds to step S1108.

In step S1107 the controller unit 205 executes a copy function in accordance with a copy setting that is set through a GUI or the like before this step, and with this executes a copy job. At that time, post-processing for the sheet processing apparatus 250 is caused to execute as necessary.

In step S1108 the controller unit 205 executes processing corresponding to an operation from an operator on the GUI 700. Then the processing returns to step S1101. Of course, in a case when there is no operation from an operator on the GUI 700, in this step processing is not executed, and the processing returns to step S1101 as is.

Next, details concerning processing in the above described step S1106 will be explained using the flowchart of FIG. 12.

In step S1201 the controller unit 205 displays the GUI 800 of FIG. 8 in place of the GUI 700 to the display screen of the operation unit 204.

In step S1202 the controller unit 205 determines which button (default binding type) out of buttons 801, 803 and 804 will be set to a selected state by default, and sets the determined button in the selected state, while setting all of the buttons other than the determined button in a deselected state.

In step S1203, the controller unit 205 waits for an input of an instruction from an operator on a display screen of the operation unit 204. Then, in a case when an input of an instruction through the operation unit 204 is detected, the processing proceeds to step S1204.

In step S1204 the controller unit 205 determines whether or not the button 804 is instructed. In the case that the result of this determination is that the button 804 is instructed, the processing proceeds to step S1205, and in the case that the button 804 is not instructed, the processing proceeds to step S1208.

In step S1205 the controller unit 205 determines whether or not the message which is based on the information concerning sheets suitable for stapleless binding processing is currently being displayed on the display screen of the operation unit 204. In the case that the result of this determination is that the message is being displayed, the processing proceeds to step S1207, and in the case that the message is not being displayed, the processing proceeds to step S1206.

In step S1206, the controller unit 205 obtains the “information concerning sheets suitable for stapleless binding processing” which the media management unit 211 manages within the HDD 209. When this is obtained, the media management unit 211 reads out the “information concerning sheets suitable for stapleless binding processing” from the HDD 209 and provides it to the controller unit 205. Additionally, when the copy function program 605 is executed, if the “information concerning sheets suitable for stapleless binding processing” which is managed by the media management unit 211 in the HDD 209 is obtained, the media management program 610 is called as appropriate. Also the controller unit 205, as shown in FIG. 9, displays the message 808 based on this obtained information.

In step S1207, the controller unit 205 sets the stapleless binding as the post-processing. This setting is not a final setting but rather is a temporary setting; a setting corresponding to the button that is in the selected state when the operator instructs the button 807 is the final setting. When processing in step S1207 is completed, the processing returns to step S1203.

Meanwhile, in step S1208 the controller unit 205 determines whether or not the button 801 or the button 803 is instructed; in other words, it determines whether or not staple binding is designated with the corner setting or with the double setting. In a case that the result of this determination is that the button 801 or the button 803 is instructed, the processing proceeds to step S1209, and neither is designated the processing proceeds to step S1212.

In step S1209 the controller unit 205 determines whether or not the message which is based on the information concerning sheets suitable for stapleless binding processing is currently being displayed on the display screen of the operation unit 204. In the case that the result of this determination is that the message is being displayed, the processing proceeds to step S1210, and in the case that the message is not being displayed, the processing proceeds to step S1211.

In step S1210 the controller unit 205, after displaying a message based on information concerning sheets suitable for stapleless binding processing on the display screen of the operation unit 204, clears and hides the message.

In step S1211 the controller unit 205, in the case in which the button 801 is instructed, selects staple binding as the finishing processing and designates the corner of the sheets to be the position of the staple binding. On the other hand, the controller unit 205, in the case in which the button 803 is instructed, selects staple binding as the finishing processing, and designates 2 locations (double) on the left side of the sheet as the positions of the staple binding. When processing in step S1211 is completed, the processing returns to step S1203.

On the other hand, in step S1212, the controller unit 205 determines whether or not the button 807 is instructed on the GUI 800 of FIG. 8. In the case that the result of this determination is that the button 807 is instructed, the processing proceeds to step S1213, and in the case that the button 807 is not instructed, the processing proceeds to step S1214.

In step S1213 the controller unit 205 registers content set using the GUI 800 in FIG. 8 in the HDD 209. More specifically, in the case that the button 807 is designated after the button 801 or the button 803 is selected, a setting for the staple binding apparatus 254 is stored in the HDD 209. Meanwhile, in the case when the button 804 is designated after the button 807 is selected, a setting for the stapleless binding apparatus 253 is stored to the HDD 209. In this way, a finishing setting is set to a mode of a binding type which is to be applied during printing for a copy job. As long as a finishing setting is not executed once again, this setting is stored as a setting for copy jobs.

Meanwhile, in step S1214, the controller unit 205 determines whether or not the button 805 is instructed. In the case that the result of this determination is that the button 805 is instructed, the processing proceeds to step S1215, and in the case that the button 805 is not instructed, the processing proceeds to step S1216.

In step S1215 the controller unit 205 discards content set using the GUI 800.

Meanwhile, in step S1216, the controller unit 205 displays the GUI 800 of FIG. 7 in place of the GUI 700 to the display screen of the operation unit 204.

### Second Embodiment

In the present embodiment, a display form of the message based on the information concerning sheets suitable for the stapleless binding processing is different from that of the first embodiment. In the present embodiment, it is assumed that there is a desire that a message having an amount of information which is more than that of the message 808 shown in FIG. 9 be displayed. For example, in FIG. 9, while information concerning sizes of sheets and a maximum number of sheets is provided, information concerning sheet types which can be used on the multi-function peripheral 200 is not provided. Also, in some cases information of grammages and surface properties and the like of a sheet can be considered to be advantageous to users who wish to use stapleless binding. In the present embodiment, this kind of situation is envisioned, and more detailed information is presented more efficiently than the first embodiment. Additionally, an explanation is given below predominantly concerning the differences from the first embodiment, and so long as the following does not touch upon something in particular, it is assumed that it is the same as in the first embodiment.

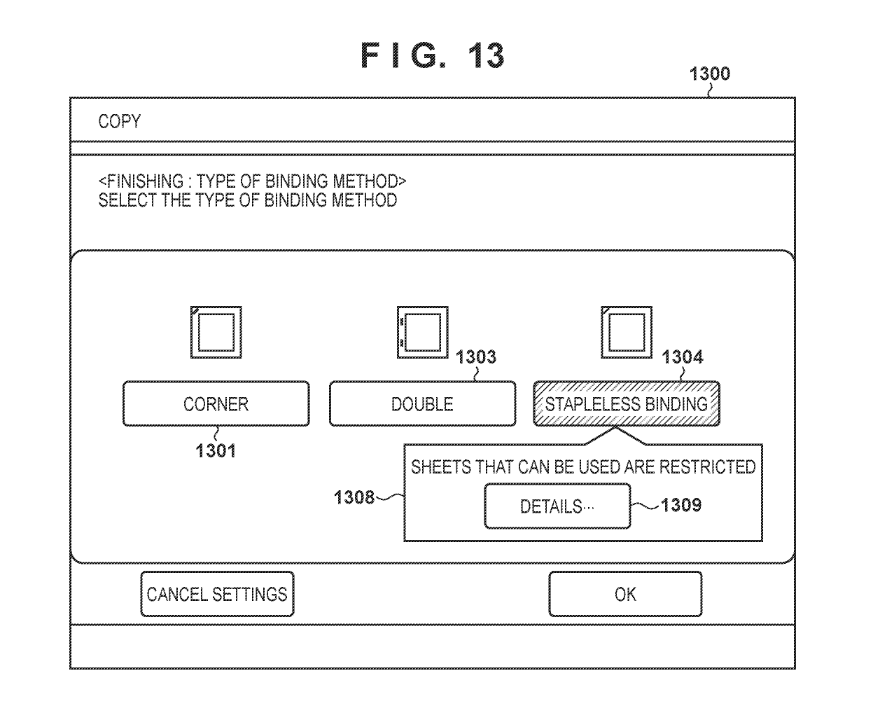

In the present embodiment, when an operator instructs the button 804 in the GUI 800 of FIG. 8, a message 1308 as shown in FIG. 13 is displayed on the display screen of the operation unit 204. In FIG. 13, since the button 804 is in a selected state, it is displayed invertedly, and within the message 1308 it is only described that there is a restriction on sheets which can be used for stapleless binding and no specific information is displayed concerning sheets; instead a button 1309 is displayed.

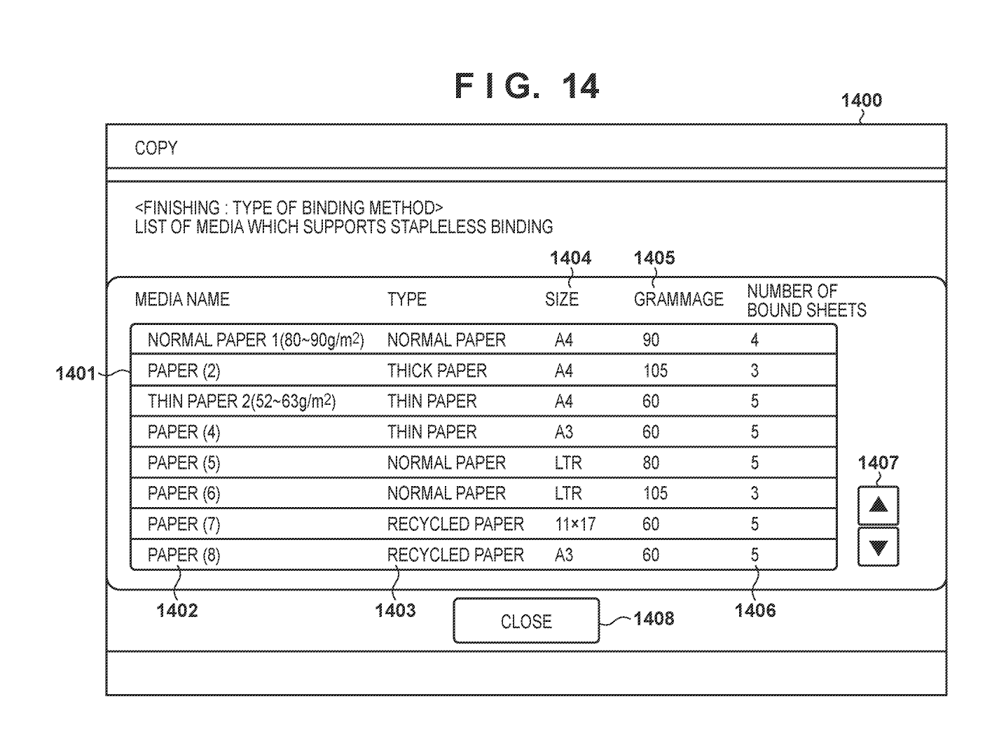

Here, when the operator instructs the button 1309, a GUI 1400 in FIG. 14 is displayed on the display screen of the operation unit 204 in place of a GUI 1300. Additionally, the GUI 1400 of FIG. 14 may be displayed even if the button 1309 is not instructed; for example, a configuration may also be taken such that the GUI 1400 of FIG. 14 is displayed after an elapse of a predetermined time after displaying the message 1308.

Within an area 1401 information concerning sheets suitable for stapleless binding processing is displayed in a list, and the amount of display information is more than in the first embodiment. When the operator touches the button 1309, the controller unit 205, obtains the “information concerning sheets suitable for stapleless binding processing” which the media management unit 211 manages within the HDD 209. Then the controller unit 205 displays the obtained information within the area 1401, as shown in FIG. 14.

The information displayed within the area 1401 is a sheet name 1402, a sheet type 1403, a sheet size 1404, a grammage 1405 and a number of sheets 1406 that can be bound. Especially with regards to the number of sheets which can be bound, the maximum number of sheets differs in accordance with the sheet type and the grammage and the like. In the first embodiment as shown in FIG. 9, the only information provided is the maximum number of sheets; however, in the present embodiment, it is possible to display individually the maximum number of sheets for which stapleless binding can be performed for each type of a sheet. Accordingly, it is possible to provide a user with a greater amount of information as well as information which is more detailed concerning sheets which are suitable for stapleless binding.

In a case where the “information concerning sheets suitable for stapleless binding processing” which is managed by the media management unit 211 within the HDD 209 does not fit within the area 1401, when an operator touches up-down buttons 1407, it is possible to cause the information to scroll up or down within the area 1401.

Also, when the operator instructs a button 1408, the controller unit 205 displays the GUI 1300 of FIG. 13 in place of the GUI 1400 to the display screen of the operation unit 204.

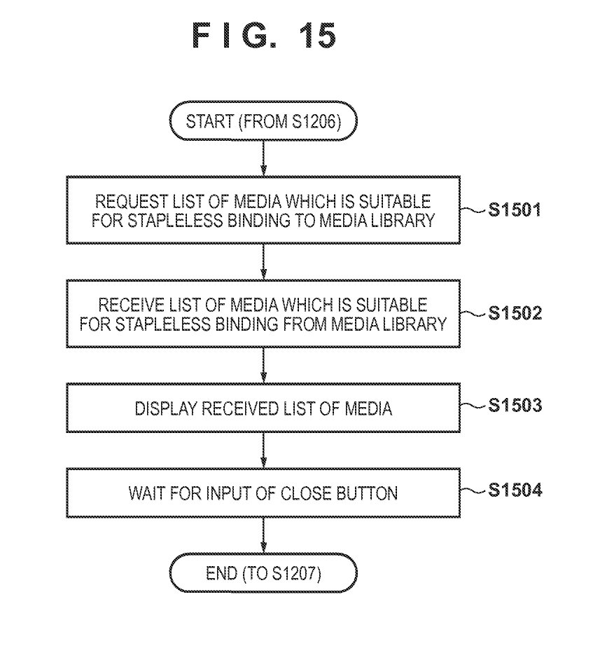

In the present embodiment, just as in the first embodiment, when the controller unit 205 executes the copy function program 605, it executes processing in accordance with the flowcharts of FIGS. 11 and 12. However, also in the present embodiment, it executes a process in accordance with a flowchart of FIG. 15 between step S1206 and step S1207.

Also, in the present embodiment, in step S1206 the controller unit 205 displays on the display screen of the operation unit 204 the message 1308 which is exemplified in FIG. 13, and not the message 808 exemplified in FIG. 9. Then, when the button 1309 in the message 1308 is instructed, the processing proceeds to step S1501.

In step S1501 the controller unit 205 sends an acquisition request to the media management unit 211 for the “information concerning sheets suitable for stapleless binding processing” which the media management unit 211 manages within the HDD 209.

In step S1502 the media management unit 211 sends the “information concerning sheets suitable for stapleless binding processing” which is read out from the HDD 209 that is requested by the controller unit 205, to the controller unit 205. With this, the controller unit 205 is able to obtain the “information concerning sheets suitable for stapleless binding processing” from the media management unit 211.

In step S1503 the controller unit 205 causes the GUI 1400 on which information obtained from the media management unit 211 in step S1502 is displayed as a list within the area 1401 to be displayed on the display screen of the display screen of the operation unit 204.

In step S1504, the controller unit 205 waits until the button 1408 is instructed, and when the button 1408 is instructed, displays on the display screen of the operation unit 204 the GUI 1300 of FIG. 13 in place of the GUI 1400. Then the processing proceeds to step S1207.

### Third Embodiment

In the GUI 1400 of FIG. 14 explained in the second embodiment, the information concerning sheets suitable for stapleless binding processing is only displayed as a list. In the present embodiment, not only is this kind of information displayed as a list, but also information concerning a desired sheet can be selected from the listed information.

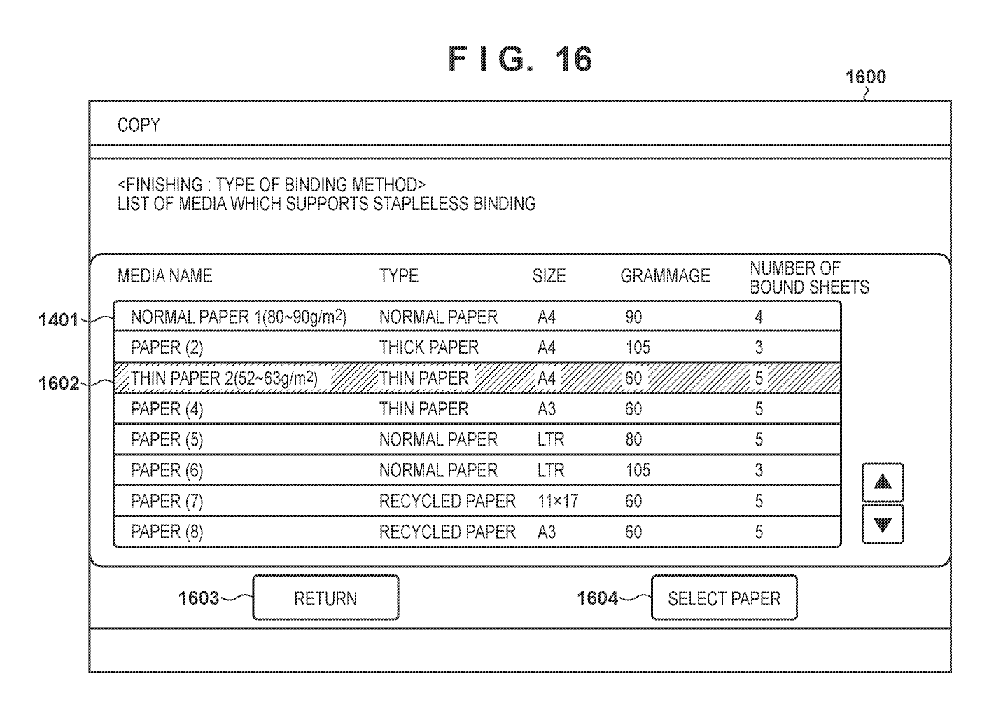

Additionally, an explanation is given below predominantly concerning the differences from the second embodiment, and so long as the following does not touch upon something in particular, it is assumed that it is the same as in the second embodiment. In the present embodiment, there is a difference from the second embodiment in that a GUI 1600 of FIG. 16 is displayed in place of the GUI 1400 of FIG. 14.

In the same way as the second embodiment, within the area 1401, the information concerning sheets suitable for stapleless binding processing is displayed in a list; however, in the present embodiment, in the area 1401, a displayed line of information concerning a desired sheet can be selected. The operator, by touching a line of information concerning a desired sheet, can designate the desired sheet to be the type of sheet for use during copying. In FIG. 16 the third line from the top within the area 1401 (row 1602) is designated, and sheets having the sheet name “thin paper 2 (52-63 g/m2)” are designated as the sheets used during copying.

When an operator instructs a button 1603, the controller unit 205 discards content (a sheet type selected as the sheets used during copying) set for the GUI 1600 in FIG. 16. Then the controller unit 205 displays on the display screen of the operation unit 204 the GUI 1300 of FIG. 13 in place of the GUI 1600.

On the other hand, when an operator instructs a button 1604, the controller unit 205 registers the content (the sheet type selected as a sheets used during copying) set for the GUI 1600 in FIG. 16, to the HDD 209 as a sheet setting for when copying. Then the controller unit 205 displays on the display screen of the operation unit 204 the GUI 1300 of FIG. 13 in place of the GUI 1600.

Additionally, in a case when the sheet designated using the GUI 1600 of FIG. 16 is set in the sheet feeding unit 220, there is no problem. However, in a case when the sheet designated using the GUI 1600 of FIG. 16 is not set in the sheet feeding unit 220, so long as the sheets are not supplied to the sheet feeding unit 220 a copy job cannot be executed. In such a case, a message is displayed on the display screen of the operation unit 204 to prompt the operator such that the sheets selected on the GUI 1600 are supplied to the sheet feeding unit 220.

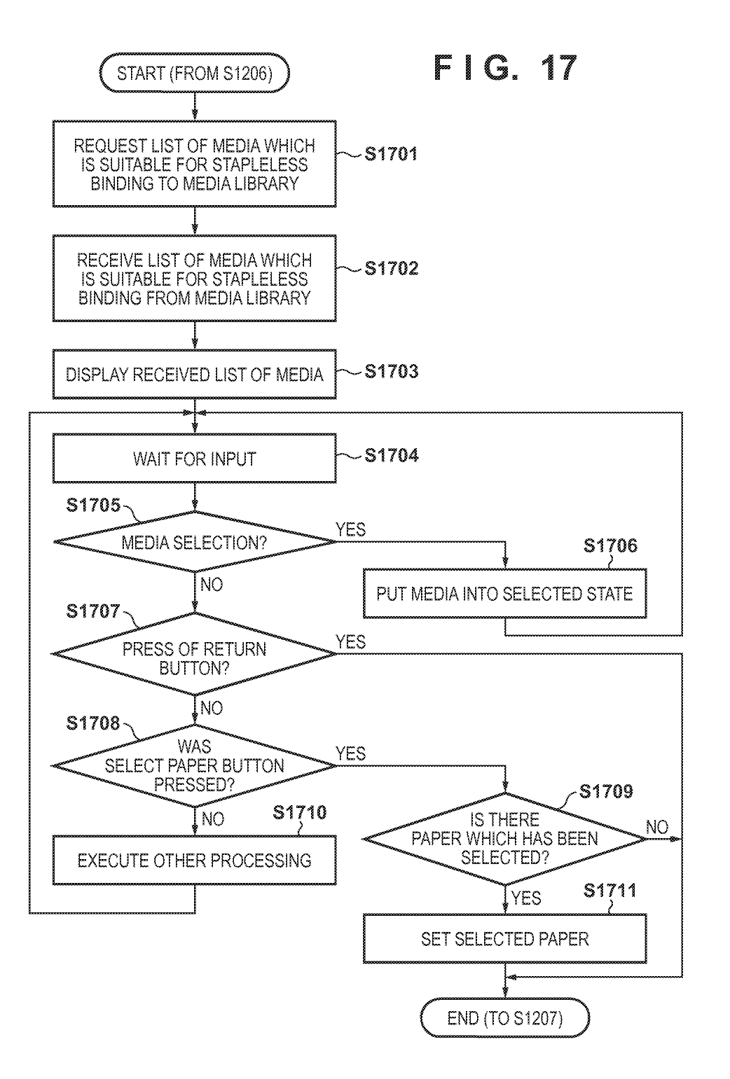

In the present embodiment, just as in the first embodiment, when the controller unit 205 executes the copy function program 605, it executes processing in accordance with the flowcharts of FIGS. 11 and 12. However, also in the present embodiment, it executes a process in accordance with a flowchart of FIG. 17 between step S1206 and step S1207.

Also, in the present embodiment, in step S1206 the controller unit 205 displays on the display screen of the operation unit 204 the message 1308 which is exemplified in FIG. 13, and not the message 808 exemplified in FIG. 9. Then, when the button 1309 in the message 1308 is instructed, the processing proceeds to step S1701.

Also, since the processing in step S1701 and step S1702, is the same as the processing in the above described step S1501 and step S1502, an explanation corresponding to these steps will be omitted.

In step S1703 the controller unit 205 causes the GUI 1600 on which information obtained from the media management unit 211 in step S1702 is displayed as a list within the area 1401 to be displayed on the display screen of the display screen of the operation unit 204.

In step S1704 the controller unit 205 waits for an input of an instruction on the GUI 1600. Then if there is input of an instruction on the GUI 1600, the processing proceeds to step S1705.

In step S1705 the controller unit 205 determines whether or not there was a touch operation from an operator on a line within the area 1401, in other words, it determines whether or not a line of information was selected from information of each line that is displayed within the area 1401. In the case that the result of this determination is that a line of information was selected, the processing proceeds to step S1706, and in the case that a line of information was not selected, the processing proceeds to step S1707.

In step S1706 the controller unit 205 puts the selected line into a selected state and displays it. Concerning the approach to displaying a line which is in a selected state, the approach is not limited to anything particular method. For example, the line may be displayed as highlighted, or may be caused to be displayed invertedly. When processing in step S1706 is completed, the processing returns to step S1704.

Meanwhile, in step S1707, the controller unit 205 determines whether or not the button 1603 is instructed. In a case where the result of this determination that the button 1603 is instructed, the controller unit 205 discards content set on the GUI 1600, the GUI 1300 of FIG. 13 is displayed on the display screen of the operation unit 204 in place of the GUI 1600, and the processing proceeds to step S1207. On the other hand, as a result of this determination, in the case where the button 1603 is not instructed, the processing proceeds to step S1708.

In step S1708, the controller unit 205 determines whether or not the button 1604 is instructed. In the case that the result of this determination is that the button 1604 is instructed, the processing proceeds to step S1709, and in the case that the button 1604 is not instructed, the processing proceeds to step S1710.

In step S1709, the controller unit 205 determines whether or not a line within the area 1401 is in a selected state. In a case where the result of this determination is that a line is in a selected state, the processing proceeds to step S1711. On the other hand, in a case when there is no line which is in the selected state, the controller unit 205 discards content set on the GUI 1600, the GUI 1300 of FIG. 13 is displayed on the display screen of the operation unit 204 in place of the GUI 1600, and the processing proceeds to step S1207.

On the other hand, in step S1711, the controller unit 205 registers, as a copy setting, in the HDD 209 that the sheets which correspond to the line which is in the selected state within the area 1401 are the sheets to be used during copying. Then the controller unit 205 displays the GUI 1300 of FIG. 13 on the display screen of the operation unit 204 in place of the GUI 1600, and the processing proceeds to step S1207.

On the other hand, in step S1710, when another button is instructed, such as a button for scrolling up or down, the controller unit 205 performs a process in accordance with the button, and afterwards the processing returns to step S1704. Additionally, in a case when a button is not instructed, processing is not performed, and the processing returns to step S1704.

### Fourth Embodiment

In the first embodiment, in a case when stapleless binding is instructed, in other words when the button 804 is instructed, a message is displayed based on the information concerning sheets suitable for stapleless binding processing. In the present embodiment, irrespective of the instruction for the button 804, a message based on the information concerning sheets suitable for stapleless binding processing is displayed.

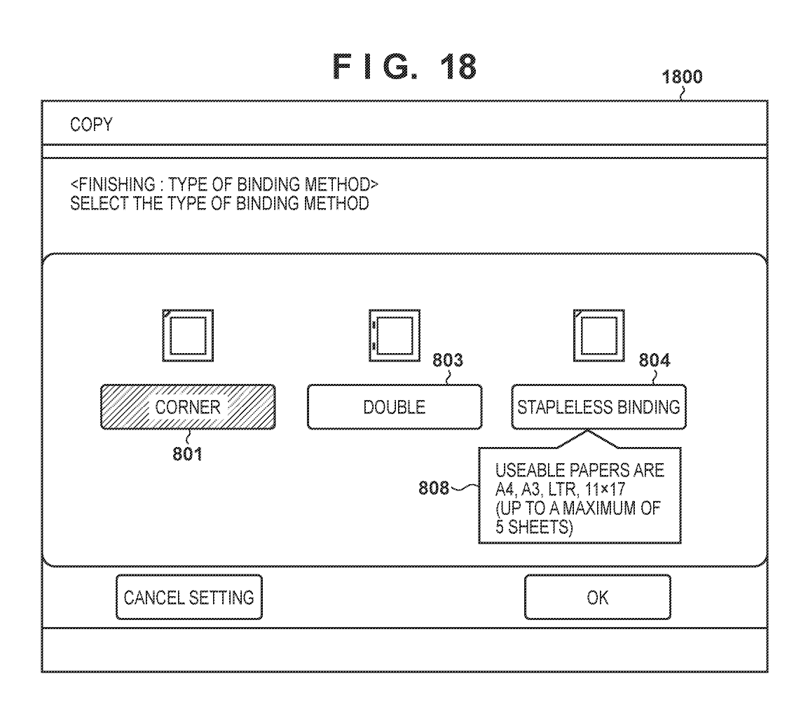

Additionally, an explanation is given below predominantly concerning the differences from the first embodiment, and so long as the following does not touch upon something in particular, it is assumed that it is the same as in the first embodiment. In the first embodiment, in a case when the button 701 is instructed on the GUI 700, the GUI 800 is displayed, and in a case when the button 804 is instructed on the GUI 800, as shown in FIG. 9, a message based on the information concerning sheets suitable for stapleless binding processing is displayed. In the present embodiment, in a case when the button 701 is instructed for the GUI 700, a GUI 1800 shown in FIG. 18 is displayed.

In the GUI 1800 since the button 801 is designated as a default binding type, the button 801 is in a selected state. Also, the GUI 1800 displays the message 808 based on the information concerning sheets suitable for stapleless binding processing. In this way, in the present embodiment, even when an operator does not designate stapleless binding, the information concerning sheets suitable for stapleless binding processing is communicating to the operator.

As described above, when compared to staple binding, stapleless binding has more restrictions concerning which sheets are suitable. Accordingly, when the button 804 is displayed at the same level as the button 801 and the button 803, there is a possibility of introducing a misunderstanding where a user believes the message about which sheets are suitable applies to all items at the same level. Rather than perform information provision of a suitable sheets when stapleless binding is selected, it is more effective from the viewpoint of convenience to provide strict information of the conditions under which sheets are suitable in advance, at the initial stage of selecting the finishing processing.

### Fifth Embodiment

An explanation is given below predominantly concerning the differences from the first embodiment, and so long as the following does not touch upon something in particular, it is assumed that it is the same as in the first embodiment.

In the GUI 1000 of FIG. 10, it is shown that a sheet of a size which is not suitable for stapleless binding, known as a user defined size, is contained in the fourth sheet feeding tray. In other words, for the multi-function peripheral 200 which is in a state in which the GUI 1000 of FIG. 10 displayed, stapleless binding cannot be applied depending on the selected sheet type (if the fourth sheet feeding tray is designated then stapleless binding cannot be applied). In such a case, an operator benefits from the presentation of the message 808 of FIG. 9, and an effect of preventing a mistake, and inhibiting generation of an improper resulting document is obtained.

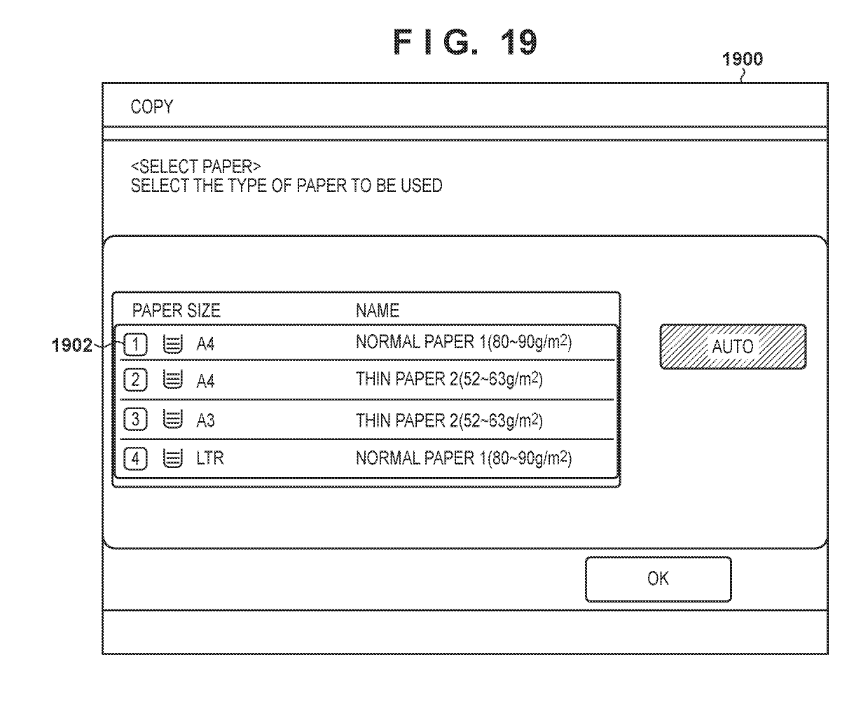

On the other hand, a GUI 1900 of FIG. 19 is displayed rather than the GUI 1000 of FIG. 10. For the multi-function peripheral 200 that is in a state in which the GUI 1900 of FIG. 19 is displayed, sheets for which it is possible to apply stapleless binding are contained in all of the sheet feeding trays. In such a case, since it is possible to apply stapleless binding no matter which sheet is selected, there is a low possibility that an operator would suffer a disadvantage even when the presentation of the message 808 of FIG. 9 is omitted.

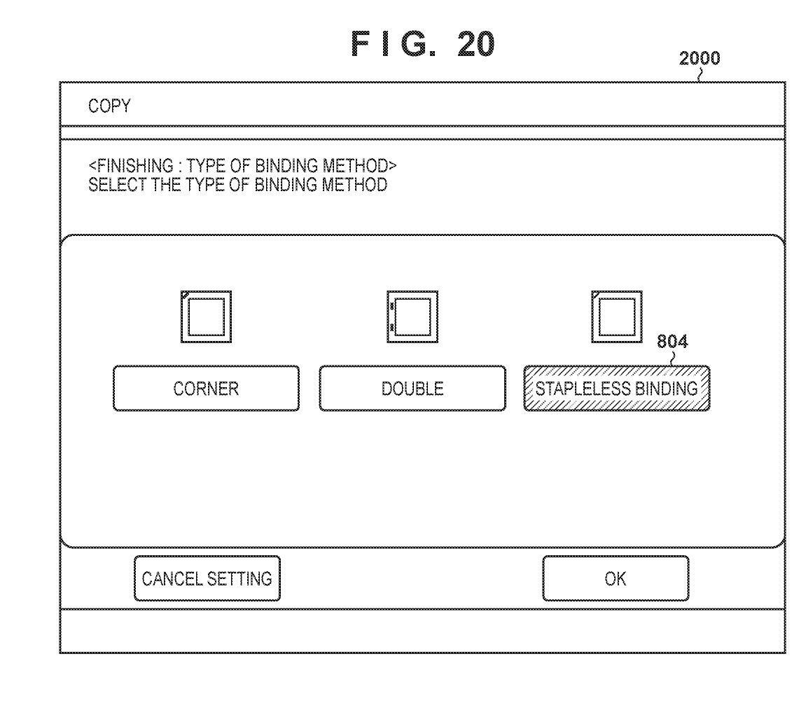

In such a case, even when the button 804 is instructed for the GUI 800 of FIG. 8, as shown in a GUI 2000 of FIG. 20, the display of the message 808 may be omitted even when the button 804 is in the selected state.

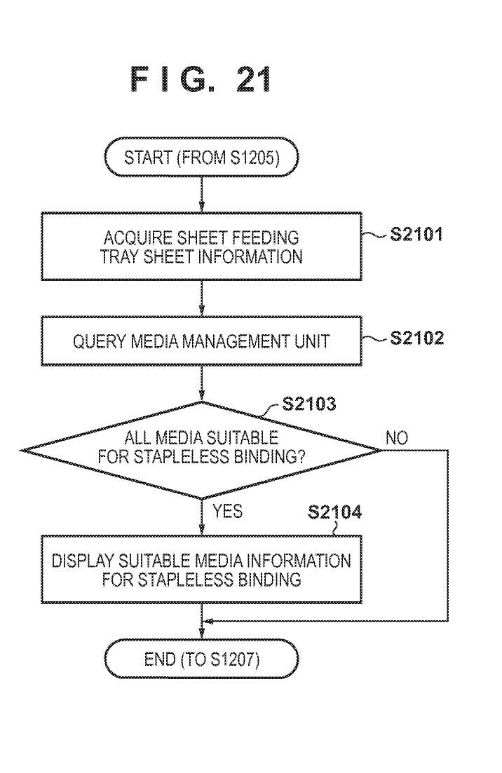

In the present embodiment, the point that in step S1206 a process is executed in accordance with a flowchart of FIG. 21 is different from the first embodiment. In other words, if step S1206 is removed, similarly to in the first embodiment, processing is executed in accordance with a flowchart of FIGS. 11 and 12 by the controller unit 205 executing the copy function program 605 in the present embodiment as well.

In step S2101 the controller unit 205 queries the media management unit 211, and causes information concerning all sheets which are set to the sheet feeding unit 220 to be acquired.

In step S2102, the controller unit 205 queries the media management unit 211 as to whether or not all sheets set in the sheet feeding unit 220 are sheets that are suitable for stapleless binding processing. However the media management unit 211 uses information acquired in step S2101, determines whether or not all sheets set to the sheet feeding unit 220 are suitable sheets for stapleless binding processing, and sends the result of the determination to the controller unit 205.

For example, the media management unit 211 focuses on sheet sizes, and determines whether or not the sizes of the sheets set to the sheet feeding unit 220 match a predetermined sizes which are sizes of sheets which are suitable for stapleless binding processing. Then in a case when the media management unit 211 determines they all match, the media management unit 211 sends something to the effect that all sheets set to the sheet feeding unit 220 are sheets which are suitable for stapleless binding processing to the controller unit 205. On the other hand, in a case when it is determined that the size of sheets which are set to the sheet feeding unit 220 does not match a predetermined size which is a size of a sheet which is suitable for stapleless binding processing, it sends something to that effect to the controller unit 205. Of course, even when focusing on other items, the substantive content of the processing is the same.

In a case when all sheets set to the sheet feeding unit 220 are sheets that are suitable for stapleless binding processing, the processing proceeds to step S1207 through step S2103. On the other hand, if even one sheet of the sheets set to the sheet feeding unit 220 is a sheet which is not suitable for stapleless binding processing, the processing proceeds to step S2104 through step S2103.

In step S2104, the controller unit 205 obtains the “information concerning sheets suitable for stapleless binding processing” which the media management unit 211 manages within the HDD 209. The controller unit 205, as shown in FIG. 9, displays the message 808 based on this obtained information.

### Sixth Embodiment

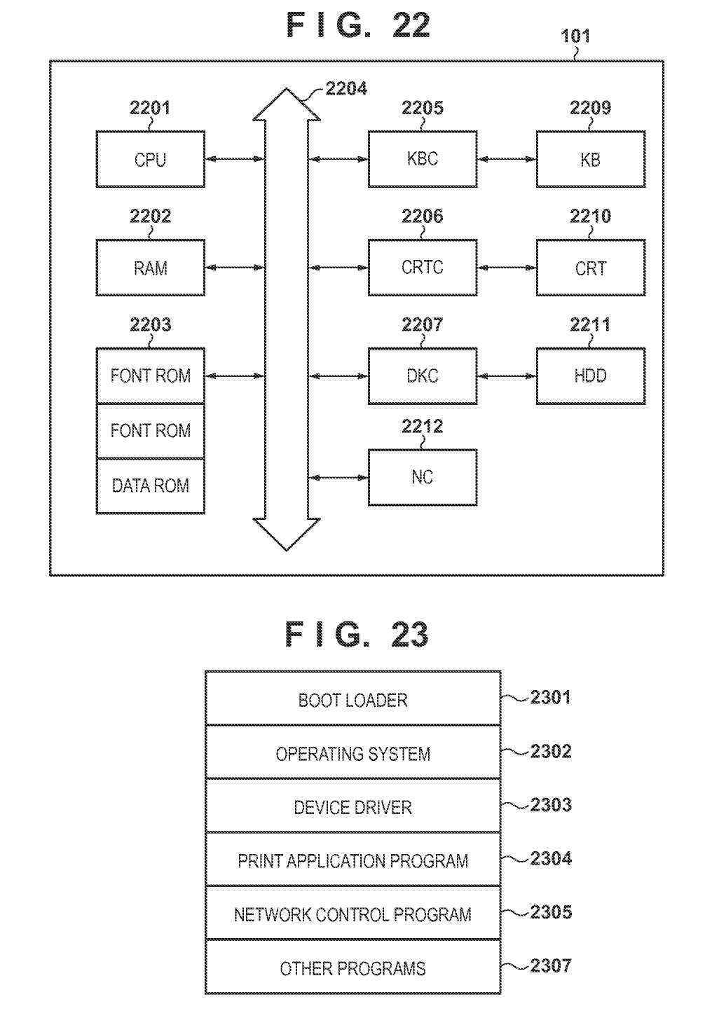

The processing explained in the first-fifth embodiments was explained as being performed by the multi-function peripheral 200. However, this kind of processing may be performed on the computer 101 side. In other words, both the computer 101 and the multi-function peripheral 200 can be applied to an information processing apparatus which, in a case when stapleless binding processing is designated as post-processing for sheets to be printed, displays on a screen information which was previously set as information concerning sheets suitable for stapleless binding processing. Next, explanation is given for a hardware configuration example of the computer 101 using a block diagram in FIG. 22.

A CPU 2201 executes processing using computer programs and data stored in a RAM 2202 or a ROM 2203 (a ROM which includes font ROMs and a data ROM). With this the CPU 2201 both performs an operation control of the computer 101 on the whole, and executes each process which will be explained later as being performed by the computer 101.

The RAM 2202 includes an area for storing data and computer programs which are loaded from the ROM 2203 or an HDD 2211. Furthermore the RAM 2202 comprises an area for storing data received from an external device such as the multi-function peripheral 200 and the like through an NC (network controller) 2212. Furthermore, the RAM 2202 comprises a work area used in a case where the CPU 2201 executes various the processing. In this way, the RAM 2202 can provide various areas as appropriate.

The ROM 2203 includes font ROMs and a data ROM, and each of them stores font data, setting data or the like of the computer 101. Also, other non-volatile data such as a boot program is stored in the ROM 2203.

A KBC 2205 is a keyboard controller, and a KB (keyboard) 2209 is connected to the KBC 2205. A user of the computer 101 is able to input to the CPU 2201 various instructions by operating the KB 2209 through the KBC 2205.

A CRTC 2206 is a CRT controller and a CRT 2210 is connected to the CRTC 2206. The CRT 2210 is a display apparatus which is able to display results of processing by the CPU 2201 as text and images.

A DKC 2207 is a disk controller and the HDD 2211 is connected to the DKC 2207. An OS (operating system), data and computer programs which are for causing the CPU 2201 to execute each process explained as being performed by the computer 101 are saved in the HDD 2211. This computer program also includes driver software of the multi-function peripheral 200. Data and computer programs which are saved in the HDD 2211 are loaded appropriately to the RAM 2202 in accordance with control by the CPU 2201, and are processing targets of the CPU 2201.

The NC 2212 is for performing data communication with the multi-function peripheral 200 through the network 100. All of the CPU 2201, the RAM 2202, the ROM 2203, the KBC 2205, the CRTC 2206, the DKC 2207 and the NC 2212 are connected to a shared bus 2204.

An explanation will be given using FIG. 23 concerning several of the computer programs included in the computer programs saved to the HDD 2211 which are related to the following explanation.

Since each of a boot loader 2301 and an operating system 2302 are the same as the boot loader 601 and the operating system 602 in FIG. 6, a corresponding explanation is omitted.

A device driver 2303 is a program for controlling various hardware connected to the computer 101, and includes a program for controlling the KBC 2205, the CRTC 2206, the DKC 2207 and the like.

A printing application program 2304 is a generic term for programs which operate on the computer 101, and has as its objective to provide various functions and services to a user. The printing application program 2304 includes a function for generating or editing print job data. Similarly the printing application program 2304 has a function for converting print settings that corresponds to various print requirements set from a setting screen (not shown) of an application. Additionally, it is possible for each application to conversely convert from a setting included print settings into corresponding internal information required for controlling a display item of a setting screen of the printing application program 2304. Additionally, the printing application program 2304 includes a function for selecting a print setting file saved within the HDD 2211 and generating print job data. The printing application program 2304 includes as a print setting a capability for converting to a PDL command format or a JDF format, and combining with target print data to generate print job data.

A network control program 2305 is a program which is executed when transmitting print job data generated by the printing application program 2304 to the multi-function peripheral 200 through the network 100. The same program can be configured to include a function for transmitting print job data and obtaining progress information of a print job which is executed by the multi-function peripheral 200 after transmitting. Although other programs 2307 which do not correspond to any of the above described programs are included in the program group, a detailed explanation of these is omitted.

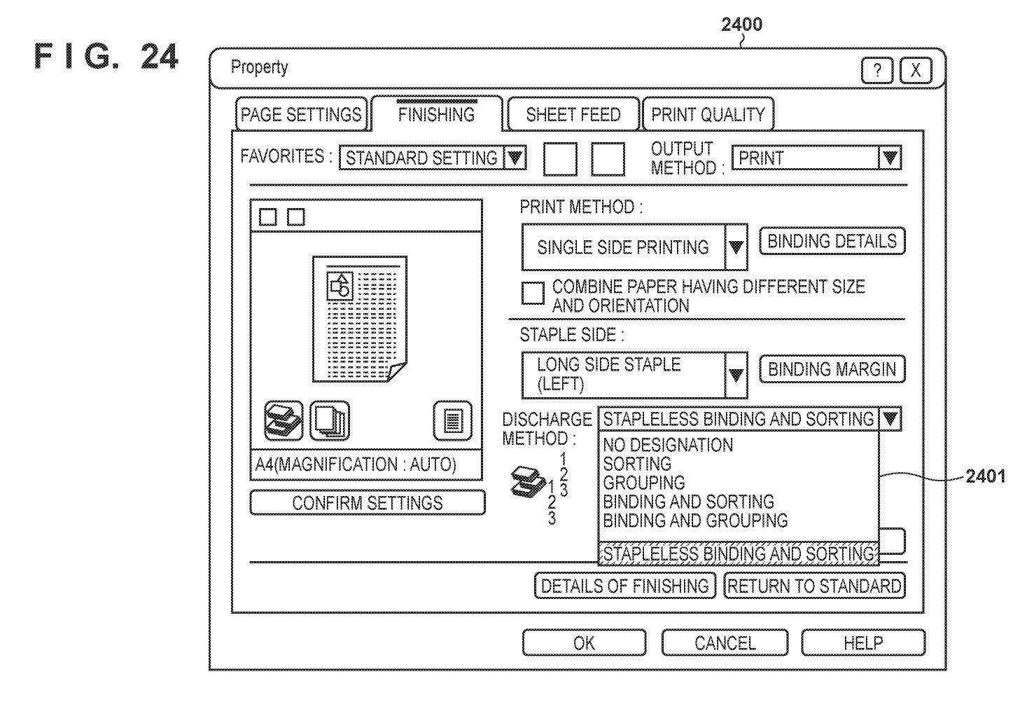

FIG. 24 is a view for illustrating an example of a screen (a GUI 2400) which includes a setting concerning finishing which is a print setting screen that is displayed by the CPU 2201 executing the printing application program 2304 to control the CRTC 2206, and thereby displaying to the CRT 2210.

When a user operates the KB 2209 and instructs a pull-down menu 2401 corresponding to “discharge method”, discharge methods are displayed in a list in the pull-down menu 2401. The discharge method corresponds to the GUI 800 of FIG. 8. As shown in FIG. 24, stapleless binding is one of the discharge methods and can be designated. In FIG. 24, the item for stapleless binding is selected, and this item is displayed invertedly. Closing the pull-down menu 2401 when an item is displayed invertedly causes that item to be selected for the discharge method.

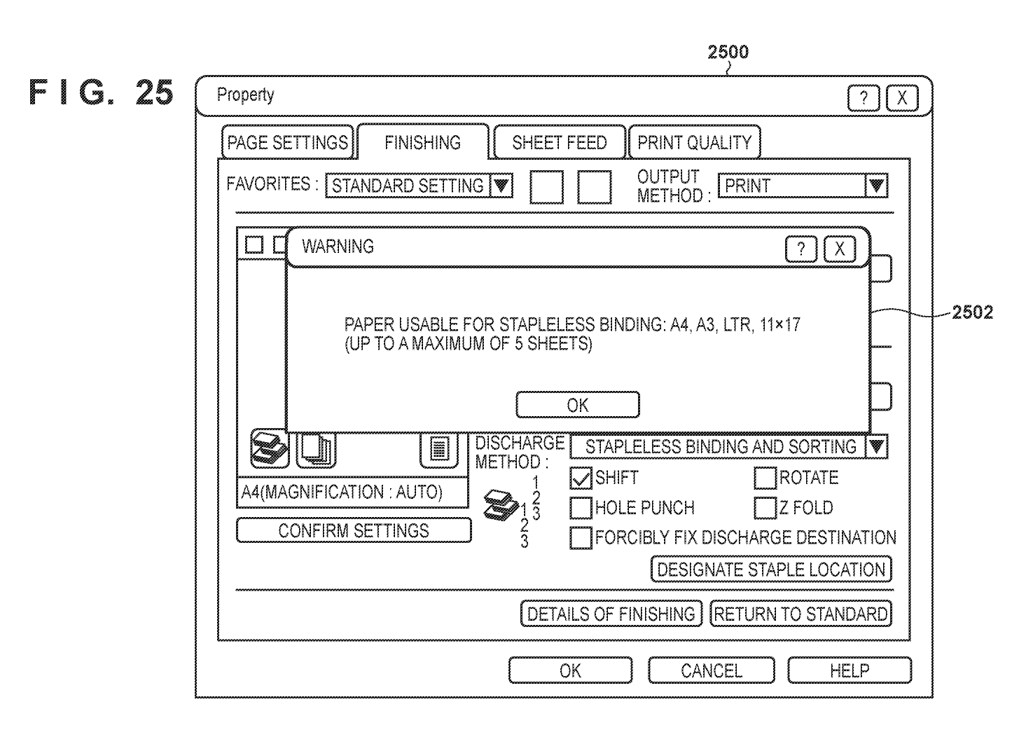

For the GUI 2400 of FIG. 24, when stapleless binding is selected on the pull-down menu 2401 and the pull-down menu 2401 is closed, as shown in FIG. 25, a message window 2502 based on the “information concerning sheets suitable for stapleless binding processing” is displayed. The message window 2502 corresponds to the message 808 shown in FIG. 9.

### Variation

Configuration may be taken such that the embodiments explained above are combined in part or as a whole as appropriate. Also, in the first-fifth embodiments execution of processing and control is explained as being performed by the controller unit 205; however a part or the whole of the processes may be executed by an externally-attached controller, or the like, of a housing separate from the multi-function peripheral 200. Also, a “sheet” is a print medium such as paper, or the like, for each of the above explained embodiments, and it is assumed that it is medium in a sheet form on which an image or text is can be printed.

Also, in the above explained embodiments, the “information concerning sheets suitable for stapleless binding processing” was explained as being created beforehand, and saved to the HDD 209; however, a configuration may also be taken such that it is possible for an operator to appropriately edit this information. For example, assume an operator operates buttons which are arranged on the display screen of the operation unit 204 or hard keys, and inputs an instruction for editing the “information concerning sheets suitable for stapleless binding processing”. Here, the controller unit 205 requests of the media management unit 211 that the “information concerning sheets suitable for stapleless binding processing” be obtained. The media management unit 211 reads out the “information concerning sheets suitable for stapleless binding processing” in accordance with this request from the HDD 209, and sends the information to the controller unit 205. The controller unit 205 displays the “information concerning sheets suitable for stapleless binding processing” received from the media management unit 211 on the display screen of the operation unit 204, and accepts an editing instruction from the operator on the information. The operator is able to edit one or more pieces of information by operating the operation unit 204. For example, it is possible to change a sheet size and add information concerning a new sheet. When the operator inputs an instruction to the effect of the editing is complete by operating the operation unit 204, the controller unit 205 updates the information by causing the content edited this time to be reflected in “information concerning sheets suitable for stapleless binding processing” saved in the HDD 209.

In this way, the “information concerning sheets suitable for stapleless binding processing” saved to the HDD 209 can be edited as appropriately. Additionally, concerning the approach to the editing, it is not limited to a particular method, nor is it limited to a particular editing timing or condition.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-114373, filed Jun. 2, 2014, which is hereby incorporated by reference herein in its entirety.

What is claimed is:

1. An information processing apparatus, comprising:
a reception unit configured to receive a setting for sheet processing including a selection of binding processing; and
a display unit configured to, when the reception unit receives the setting for the sheet processing, display identifiably an attribute of a sheet for which binding can be performed without using a staple from out of a plurality of attributes of sheets.

2. The information processing apparatus according to claim 1, wherein
the setting of the sheet processing includes a selection of binding processing for binding sheets using a staple or binding processing for binding sheets without using a staple; and
the display unit is configured to display identifiably the attribute of the sheet for which binding can be performed without using a staple without displaying identifiably an attribute of a sheet for which binding using a staple can be performed.

3. The information processing apparatus according to claim 1, wherein the attribute of the sheet includes a size of the sheet.

4. The information processing apparatus according to claim 1, wherein the attribute of the sheet includes a type of the sheet.

5. The information processing apparatus according to claim 1, wherein the display unit, based on selection of the binding processing for binding sheets without using a staple, displays identifiably the attribute of the sheet for which binding can be performed without using the staple.

6. The information processing apparatus according to claim 1, wherein the display unit, prior to selection of the binding processing for binding sheets without using a staple, displays identifiably the attribute of the sheet for which binding can be performed without using the staple.

7. The information processing apparatus according to claim 1,
further comprising a plurality of sheet storage units, and
wherein the display unit prevents from displaying identifiably the attribute of the sheet for which binding can be performed without using a staple if all sheets contained in the plurality of sheet storage units are sheets for which binding can be performed without using a staple.

8. The information processing apparatus according to claim 1, further comprising a sheet processing unit configured to execute sheet processing based on the setting that the reception unit received.

9. The information processing apparatus according to claim 8,
further comprising a printing unit configured to print an image on a sheet, wherein
the sheet processing unit executes the sheet processing on the sheet on which the printing unit printed the image.

10. The information processing apparatus according to claim 1, further comprising:
a generation unit configured to generate a print job including the setting that the reception unit received; and
a transmission unit configured to transmit to a printing apparatus the print job that the generation unit generated.

11. A method of controlling an information processing apparatus, comprising:
a reception step of receiving a setting for sheet processing including a selection of binding processing; and
a display step of, when the setting for the sheet processing is received in the reception step, displaying identifiably an attribute of a sheet for which binding can be performed without using a staple from out of a plurality of attributes of sheets.

12. A non-transitory computer-readable storage medium storing a program for causing a computer to execute the method of controlling the information processing apparatus according to claim 11.
